(19) United States
(12) Patent Application Publication
(10) Pub. No.: US 2016/0299606 A1
(43) Pub. Date: Oct. 13, 2016

(54) USER INPUT PROCESSING DEVICE USING LIMITED NUMBER OF MAGNETIC FIELD SENSORS

(71) Applicant: WIDEVANTAGE INC., Seoul (KR)

(72) Inventor: Jaeyoung GO, Seoul (KR)

(21) Appl. No.: 15/100,490

(22) PCT Filed: Dec. 5, 2014
(86) PCT No.: PCT/KR2014/011964

§ 371 Date: May 31, 2016

(30) Foreign Application Priority Data
Dec. 5, 2013 (KR) 10-2013-0151009
Apr. 22, 2014 (KR) 10-2014-0048354

(51) Int. Cl. G06F 3/046; G06F 3/038; G06F 3/0488; G06F 3/0346; G06F 3/041; G06F 3/0354

(52) U.S. Cl. CPC G06F 3/046; G06F 3/0416; G06F 3/03545; G06F 3/0414; G06F 3/04883; G06F 3/0346; G06F 3/0383; G06F 2203/04104; G06F 2203/04108

(57) ABSTRACT

The present invention relates to a user input processing device using a limited number of magnetic field sensors, which senses a magnetic field from a magnetic field generator installed in a writing tool, such as a pen, using the limited number of magnetic field sensors, acquires information on a position and direction of a pen based on information on the sensed magnetic field and information on an input on a touch screen and a position of a hand of a user, and processes the acquired information as a user input. The present invention includes at least one magnetic field sensor for sensing a magnetic field, which are independent of each other, a touch inputter for sensing a touch of a writing tool or a hand, and a controller for calculating a position and direction of the writing tool or the magnetic field generator mounted in the writing tool based on a current touch position value of the touch inputter and a current magnetic field value from the magnetic field sensor.

### TECHNICAL FIELD

The present invention relates to a user input processing device, and to a user input processing device that uses a limited number of magnetic field sensors included in a smartphone or a computer, for example, a tablet, and that is configured to sense a magnetic field from a magnetic field generator installed in a writing tool, for example, a pen, using the limited number of magnetic field sensor, configured to acquire information on a position and a direction of a pen based on information on the sensed magnetic field and information on an input on a touch screen and a position of a hand of a user, and configured to process the acquired information as a user input.

### BACKGROUND ART

A touch screen used for a tablet, a smartphone or other interactive screens is a pointing device that includes a sensor installed on a display screen and configured to recognize a capacitive touch, a static pressure touch and an optical touch, and that enables a user to manually press or draw an object displayed on a screen. For example, in a capacitive touch screen, a stylus pen point formed of a conductive material may be used for touch. In a static pressure touch screen, an input of a general pointing device, for example, drawing, selecting of a menu or drawing, may be performed on the touch screen using a simple mechanical pressure of a pen point, and a capacitive/static pressure input may be performed using a touch by a user's finger.

However, in most capacitive/static pressure touch screens, it is impossible to distinguish press by a skin, for example, a hand, of a user from press by a pen (for example, a pen point) based on only an input on a touch screen. In other words, because a user needs to maintain a predetermined distance between a hand and a touch screen, instead of putting a palm near a thumb on the touch screen (that is, “palm resting”) for writing, the user felt writing is difficult and unnatural.

Also, because an input of only two-dimensional (2D) coordinates of a pen point pressing the touch screen is received, it was impossible to perform three-dimensional (3D) manipulation or intuitionally change a width or brightness of a stroke by measuring an angle or direction at which a penholder (for example, a pen body) is inclined, and a pressure applied to the touch screen. In addition, it is impossible to implement a function, for example, pen hovering, of displaying a cursor in advance in a position of a pen point when a pen approaches the touch screen.

For example, a smartphone may enable an input by a pressure and an input by a stylus pen and an input by a finger that are distinguished from each other. However, in this example, two-layer high-priced sensors may be used in a touch screen, or a high-priced pen including a power supply device, a high-priced sensor, a data communication module and a microprocessor may be required. Technologies with a capacitive scheme and a magnetic resonance published in, for example, U.S. Pat. Nos. 5,134,388, 5,898,136, 8,228,312, and the like by Wacom Co., Ltd. of Japan are used in a portion of smartphones and tablets of Samsung Electronics Co. Ltd., and accordingly an input by a pen and a press by a hand may be distinguished from each other, and a degree of force of a pen to press, that is, a pen pressure may be measured. In addition, instead of directly touching a touch screen with a pen by increasing a magnetic field signal, limited pen hovering of analyzing a position of a pen point and displaying a cursor on a display screen is possible when the pen point is floating in a position very close to a screen. However, in the above scheme, a dual layer, that is, a layer in which the touch screen recognizes a hand and a layer in which the touch screen recognizes a pen point and supplies power to a pen, needs to be implement. Also, an additional chipset is required, which may increase a cost in view of a phone and may consume a large amount of power. In addition, a complex circuit needs to be included in the pen.

In U.S. Patent Application No. 2012-0127110 of Apple Inc. and U.S. Patent Application No. 2012-0153026 of Microsoft Corporation, a circuit including a power supply and a camera, a processor and a wireless communication module are inserted in a stylus. When a point of the stylus sufficiently approaches or touches a screen of a smartphone, the camera of the stylus may recognize a visual indication finely formed on the screen to recognize a position of a pen point on the screen, and a touch by a pen and a touch by a hand may be distinguished from each other. Also, when a complex image recognition algorithm is performed on an image captured by the camera, an inclination may be expected to be measured. However, because the camera, a high-priced processor, a Bluetooth communication module, and the power source are included in the pen, costs may significantly increase.

Generally, when a sensor, for example, a camera, is used to measure a movement of a pointing device, high costs and excessive power consumption may be issues. Because a field of view of the camera is limited, it is impossible to apply the sensor in many cases in which a line of sight is not secured. Also, only when an ultrasonic sound source and a sensor face each other, a distance may be measured using an ultrasonic wave, and accordingly a directivity may be limited. Thus, it is impossible to use the sensor to measure a movement with a high degree of freedom.

A trackpad is used as a pointing device, in addition to a touch screen. The trackpad is mainly used as a device that is used for dragging or selecting by pressing with a fingertip although not displayed. Similarly to touch screens, in most trackpads, it is difficult to distinguish a pen from a hand, and it is impossible to measure a direction in which a trackpad is inclined or a degree by which the trackpad is inclined, and impossible to perform pen hovering.

To find out a position and a direction of a magnet by measuring a magnetic field, the following issues need to be solved: 1) because a sensor is affected by a magnetic field of the earth, the magnetic field of the earth is determined based on a direction of a computer on the earth and a sensor offset value is set to an arbitrary value every time other sensor chips are powered on; 2) noise occurs due to alternating current (AC) power source line, an electromagnet, and the like, in addition to the magnetic field of the earth; and 3) when a strong magnet approaches a magnetic field sensor, a ferromagnetic substance, for example, iron or nickel, located inside/outside the magnetic field sensor disturbs the magnetic field sensor, and accordingly it is difficult to perform accurate measurement. To solve the above issues, in the related art, a calibration process is performed by spacing a magnet apart from a sensor and by measuring an ambient magnetic field generated by, for example, the magnetic field of the earth while rotating sensors. However, when calibration needs to be frequently performed, availability may decrease. Also, to limit a position of a magnet in the related art, at least nine single-axis magnetic field sensors are used, and the calibration process needs to be performed before a movement is measured (http://www.acasper.org/2012/02/19/3d-magnetic-localization/).

Due to the above issues, it is impossible to sufficiently accurately measure a position or inclination of a pen using a small number of magnetic field sensors mounted in a computer for general purposes with a simple permanent magnet. In particular, it is also impossible to accurately distinguish a touch by a pen from a touch by a hand due to the above inaccuracy.

A general-purpose 3-axis magnetic field sensor (for example, a magnetometer) is mounted in most mobile devices, for example, smartphones or tablets, according to the related art. However, 3-axis magnetic field sensors are not enough to limit an angle and position of a magnet with five degrees of freedom from values of the 3-axis magnetic field sensors. In addition, calibration needs to be frequently performed due to an ambient magnetic field, which leads to inconvenience.

### DISCLOSURE OF INVENTION

### Technical Goals

An aspect is to provide a user input processing device using a limited number of magnetic field sensors that may measure a position in which a pen point draws a to stroke on a plane, a direction and angle in which a pen is inclined in a space, a pressure of the pen, and the like, using a pen including a simple permanent magnet and a small number of magnetic field sensors outside the pen, without a need to use a pen including a power transfer device, and a complex circuit and an expensive two-layer touch sensor screen, for example, technologies of Wacom Co., Ltd., or a need to include a high-priced sensor, a processor, a communication device, for example, Bluetooth, and a power supply in a stylus pen.

Another aspect is to provide a user input processing device using a limited number of magnetic field sensors that may control a width or brightness of a stroke as if a pen is actually used on paper in response to an input of an inclination of a pen holder with respect to a touch screen as well as a trajectory left by a pen point pressing the touch screen, and that may solve a problem of floating a hand above a screen for writing because it is difficult to distinguish a touch by a touch pen from a touch by a hand in the related art.

Still another aspect is to provide a user input processing device using a limited number of magnetic field sensors that may accurately distinguish a pen from a hand based on relative positions between the pen and the hand determined based on whether a user is right-handed or left-handed during writing or drawing while maintaining general-purpose components of hardware, for example, a magnetic field sensor or a touch screen.

Yet another aspect is to provide a user input processing device using a limited number of magnetic field sensors that may sufficiently accurately estimate a position of a pen point near a touch screen and may display a cursor on the touch screen even though a pen does not touch the touch screen without an additional hardware device.

A further aspect is to provide a user input processing device using a limited number of magnetic field sensors that may minimize a number of operations of calibration performed when a magnetic field is measured.

A further aspect is to provide a user input processing device that may display a cursor or on-line help in a position corresponding to a touch screen by analyzing a movement, a position or an angle of a writing tool floating above the touch screen even though the writing tool does not touch the touch screen, or may enable a user to conveniently view and edit many portions of content using a narrow display by zooming or panning content (for example, texts or images) displayed on the touch screen.

### Technical Solutions

According to embodiments, a magnetic field may be further measured, a permanent magnet may be fixed in a pen holder to distinguish a touch by a hand from a touch by a pen in response to an input on a touch screen when a user performs writing with the pen on the touch screen by putting the hand on the touch screen, and a magnetic field may be measured by a magnetic field sensor outside the pen. When the touch by the hand and the touch by the pen are performed in relatively arbitrary positions on a two-dimensional (2D) touch screen, a magnetic field by a magnet mounted in the pen may need to be sufficiently accurately measured to distinguish the touches from each other, regardless of a position of a sensor. However, it is difficult to accurately measure a magnetic field applied by the magnet due to an influence by the above-described noise, a ferromagnetic substance, and the like. According to embodiments, to accurately distinguish the touch by the hand from the touch by the pen based on a magnetic field value by the magnet in the pen in a situation in which it is impossible to accurately measure the magnetic field, a feature that touch positions of a pen point and the hand are set to an upper left side and a lower right side in a relative direction may be used as described above. In other words, when a touch is actually performed by a pen including a magnet, a magnetic field sensor may be located in a position corresponding to an increase in a difference between magnetic fields by the magnet having an influence on a magnetic field sensor, between a position of a touch by the pen point and a position of a touch by the hand. For example, a pen held by a right-hander may be located in an upper left side in comparison to a hand, and accordingly a magnetic field sensor may be disposed as close to a line drawn from the upper left side to a lower right side as possible. In this example, the magnetic field sensor may be disposed as close to a straight line connecting the magnet of the pen to a portion of the hand in contact with the touch screen as possible. Accordingly, a difference between magnetic fields having an influence on the magnetic field sensor when a single touch that is not distinguished is a touch by the hand and a touch by the pen may be maximized, and thus it is possible to accurately distinguish the touch by the hand from the touch by the pen despite noise, a ferromagnetic substance, and the like. Similarly, when a user is left-handed, a magnetic field sensor may be disposed to be close to a line drawn from an upper right side to a lower left side, that is, a straight line connecting a magnet of a pen held by the user and a portion of a hand of the user in contact with a touch screen.

A computer system, for example, a tablet or a smartphone, according to the related art includes 1) a general-purpose 3-axis magnetic field sensor for measuring a direction, 2) a touch screen, and 3) an acceleration sensor, to recognize a direction in which a user lifts a computer with respect to the direction of gravity measured using the acceleration sensor and to automatically change a software output direction with respect to a screen of hardware so that a corner of the computer corresponding to a direction opposite to the direction of gravity is oriented toward an upper side of software. In an example in which a pen and a hand are distinguished from each other on a touch screen using a touch pen including a magnet and the above device, when a user starts to use a function of distinguishing the pen from the hand or when the user lifts a computer and rotates the computer in a direction in which software is output, a magnetic field sensor may allow the user to rotate the computer to easily distinguish the pen from the hand. For example, when the user is right-handed, a 3-axis magnetic field sensor may instruct the user to rotate the computer so that the 3-axis magnetic field sensor may be located in an upper left side or a lower right side based on the user. When the user is left-handed, a sensor may instruct the user to rotate the computer so that the sensor may be located in an upper right side or a lower left side. Generally, an output may be output to instruct the user so that the 3-axis magnetic field sensor is located to be probabilistically closest to a line connecting a position of a magnet in a pen held by a hand and a portion of the hand in contact with a touch screen, and accordingly accuracy may increase. When the 3-axis magnetic field sensor is located in a middle portion of a side, instead of a corner of a quadrilateral tablet, a corner allowing a magnetic field sensor to be in the closest position to the line, among four corners of the tablet to be located at the top in a position of the user, may be instructed to be located at the top.

When a pen is floating close to a touch screen, instead of being in contact with the touch screen, the 3-axis magnetic field sensor may be used for pen hovering to estimate a position of a pen point on a screen, without an additional sensor. Because it is difficult to limit a position of a magnet with five degrees of freedom, using only the 3-axis magnetic field sensor, directivity of a pen determined based on whether a user is left-handed or right-handed or a property that a pen point is located close to the touch screen is further assumed and measured.

Although the permanent magnet is installed in the pen in the above description for convenience of description, it is obvious to use various magnetic field generators, for example, an electromagnet, a rotating magnet, and the like. Also, a pointing device including a magnet described as a stylus pen for convenience may be implemented in various forms, for example, a mouse, a ring, a thimble, and the like, when there are a magnet and a component capable of sending a touch signal to a touch screen. In particular, when a pointing device is implemented as a ring, the ring may be putted on a finger of a user or an existing simple stylus pen, a fingertip or a point of the stylus pen touches a touch screen, a magnetic field generated by a magnet in the ring may be further measured, and whether a touch is performed by a finger with the ring or by a portion of a hand, for example, a palm of hand may be determined. Also, in the present disclosure, the ‘touch screen’ described for convenience may include a device, for example, a trackpad, enabling a touch input, not a display, in addition to a screen of various schemes in which both a touch input and a display are enabled. In a device used for only an input, for example, a trackpad, a display is typically performed by a display device, for example, a screen located in a separate position.

According to the embodiments, a limited number of magnetic field sensors and a magnetic field generation source that does not need to ensure directivity due to a highest penetrability are used to measure a movement, and a permanent magnet at a little cost is included as the magnetic field generation source in a pointing device. Also, the limited number of magnetic field sensors are used to measure a magnetic field generated by a magnet (generally, the magnetic field generation source), and to measure a position of the pointing device. To increase accuracy of measurement, a scheme of rotating a permanent magnet at a constant velocity, instead of fixing the permanent magnet, and of filtering and measuring a magnitude of a signal in the same frequency band as a number of rotations of the permanent magnet may be used. Also, a scheme of using an electromagnet that generates an alternating current (AC) magnetic field of a preset frequency and of filtering and measuring a magnitude of a signal in the same frequency band as the frequency may be used.

According to the embodiments, to obtain and use meaningful information on an angle and position of a magnet dipole with a high degree of freedom from a magnetic field measured by a limited number of sensors, the following means is used. 1) A relative position or angle of a pen and a hand determined based on whether a user is right-handed or left-handed during writing or drawing is assumed. When the user is right-handed, the user may hold the pen so that the pen may be inclined to a lower right end of a touch screen, and a property that a pen point in contact with the touch screen is located in an upper left side than a hand in contact with the touch screen may be used. 2) Parameter fitting or a nonlinear optimization may be performed based on all magnetic field values measured at consecutive times as well as a magnetic field value measured once, and a large number of variables associated with an angle and position of a movement are analyzed. To this end, a user may be allowed to easily operate a pointing device including a magnet, for example, the user may move the pointing device at a constant velocity instead of rapidly changing an angle of the pointing device. Using the above schemes, sufficient information on a movement and position of a magnet may be obtained, even though an ambient magnetic field having an influence on a sensor is not analyzed through a cumbersome calibration process.

### Effects of the Invention

According to embodiments, it is possible to sense a magnetic field from a writing tool including a simple magnetic field generator only, using a limited number of 1-axis magnetic field sensors, to distinguish a touch by a pen from a touch by a hand and to calculate an angle and direction in which the pen is inclined in a space, together with a position in which a pen point draws a stroke on a plane, without a need to use a pen including a power transfer device, and a complex circuit and an expensive two-layer touch sensor screen, for example, technologies of Wacom Co., Ltd., or a need to include a high-priced sensor, a processor, a communication device, for example, Bluetooth, and a power supply in a stylus pen.

Also, according to the embodiment, it is possible to solve a problem of floating a hand above a screen for writing with a simple touch pen as a disadvantage of a touch pen according to a related art, and to determine an input of a touch pen that is desired by a user even though the user naturally performs writing and drawing by putting a palm on a touch screen similarly to writing on paper.

In addition, according to the embodiment, it is possible to change a width or brightness of a stroke based on an angle and direction in which a pen is inclined as if the pen is actually used on paper as well as a trajectory left by a pen point pressing a touch screen, or to change a type of the pen based on the angle and the direction, and to determine and process different user inputs. Also, it is possible to facilitate switching between a write function and an erase function based on a direction and an angle in which a writing tool is inclined or switching between undo functions that are frequently used and selection of the undo functions.

Moreover, according to the embodiment, it is possible to analyze a position of a pen point using a general-purpose magnetic field sensor only when the pen point approaches a touch screen instead of directly touching the touch screen, without an additional sensor, and to display a cursor using a display. In addition, when a position of a pen point of a floating pen is estimated and a cursor is displayed, an application, for example, a trackpad, in which a touch input and a display are performed in separate positions, may be useful. For example, a separate display device may need to display a position of a pen using a cursor on a separate screen even though the pen is floating and moves, and thus a user may see with eyes a position in which the pen floating above a trackpad starts a touch or a stroke using the separate screen. Accordingly, a general-purpose tablet according to the related art may be used as a trackpad of a separate computer.

Furthermore, according to the embodiment, a movement, a position in a space or an angle of a writing tool may be analyzed from a value read by a magnetic field sensor without an additional sensor even though a pen point is floating at a considerable long distance from a touch screen while the pen point is not in contact with the touch screen, and thus it is possible to allow a user to manipulate a position of a screen cursor or to easily view and manipulate a lot of information using a narrow screen of a mobile device by zooming and panning content displayed on the screen.

In addition, according to the embodiment, when zoom-in is performed based on an intersection point at which a touch screen meets an extension line of a trajectory of a writing tool approaching the touch screen, a point on the touch screen may be fixed during updating of content on the screen by zooming, and thus a user may intuitively touch the touch screen. In an example of an extremely small screen, for example, a smartwatch, an offset or a central point for zooming and panning may be set based on an angle of a trajectory left by a writing tool approaching or an angle at which the writing tool is inclined, and thus a user may easily manipulate whole content displayed on a narrow display of a mobile device in response to a zoom-out operation and details of the content in response to a zoom-in operation by automatically zooming and panning the content.

According to the embodiment, it is possible to perform the above operations using a very limited number of magnetic field sensors without a separate calibration, and thus a malfunction may not occur, a separate battery installed in a pen by a user may not need to be replaced or charged, and Bluetooth pairing may not need to be performed between a pointing device, for example, a pen, and a mobile computer.

### BRIEF DESCRIPTION OF DRAWINGS

FIG. 1 is a diagram illustrating a basic configuration of a user input processing device according to an embodiment.

FIGS. 2 and 3 illustrate examples of using the user input processing device of FIG. 1 according to a first embodiment and a second embodiment.

FIG. 4 illustrates an example in which a magnetic field is sensed by a magnetic field sensor located in a center of a circle when a magnet is located on a circumference.

FIGS. 5A and 5B illustrate examples of using the user input processing device of FIG. 1 according to a third embodiment and a fourth embodiment.

FIGS. 6 and 7 illustrate examples of using the user input processing device of FIG. 1 according to a fifth embodiment.

FIGS. 8A and 8B illustrate examples in which a user input processing device and a writing tool are located at different angles, for example, angles theta and phi.

FIGS. 9A and 9B illustrate examples of a zoom function based on a position of a writing tool in a user input processing device.

FIG. 10 illustrates an example in which a trajectory along which a writing tool arbitrarily moves on a plane parallel to a touch screen is determined by a magnetic field value of a magnetic field sensor and displayed.

FIG. 11 illustrates an example of using the user input processing device of FIG. 1 according to a sixth embodiment.

FIG. 12 illustrates an example using the user input processing device of FIG. 1 according to a seventh embodiment.

FIG. 13 illustrates an example of using the user input processing device of FIG. 2.

### BEST MODE FOR CARRYING OUT THE INVENTION

The following detailed description is provided in order to explain the example embodiments by referring to the figures.

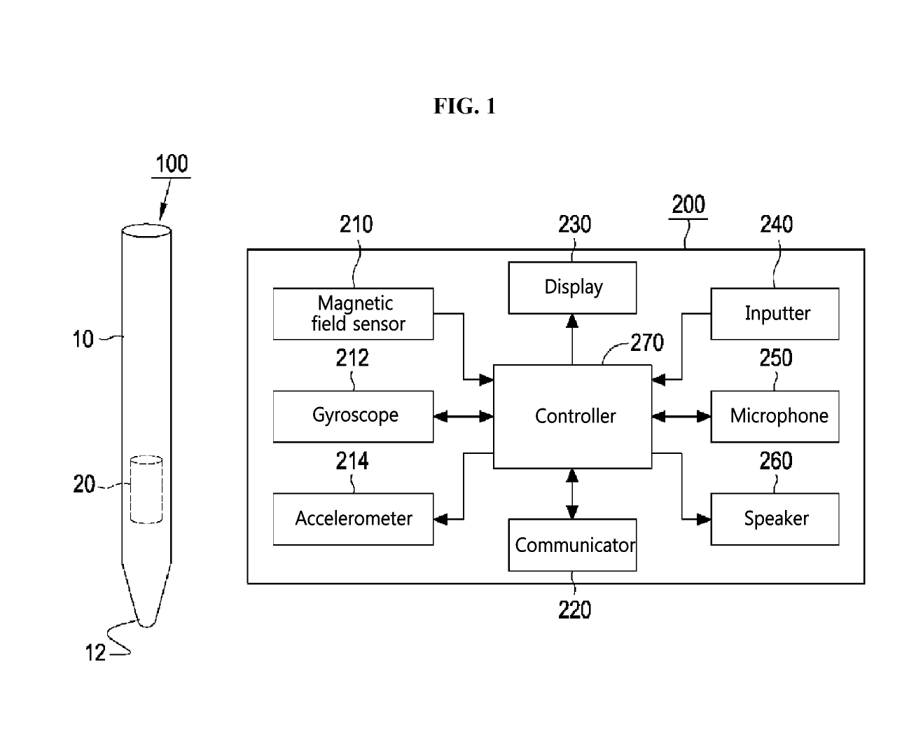

FIG. 1 is a diagram illustrating a basic configuration of a user input processing device according to an embodiment.

A user input processing device 200 is a device configured to process a user input by sensing a magnetic field from a magnetic field generator 20 included in a writing tool 100 used by a user for writing or drawing.

The writing tool 100 includes a body portion 10 held by a hand of a user, and the magnetic field generator 20 mounted in an inner surface or outer surface of the body portion 10 and configured to generate a magnetic field. A pen point 12 is formed on at least one end of the body portion 10. The magnetic field generator 20 may include a permanent magnet or an electromagnet, and may generate an alternating current (AC) magnetic field.

The user input processing device 200 includes a magnetic field sensor 210, a gyroscope 212, an accelerometer 214, a communicator 220, a display 230, an inputter 240, a microphone 250, a speaker 260, and a controller 270. The magnetic field sensor 210 may measure a magnetic field from the magnetic field generator 20 in the writing tool 100. The communicator 220 may perform a communication based on various communication schemes. The display 230 may display a variety of information and content. The inputter 240 may acquire an input from a user. The microphone 250 may acquire an external sound/voice signal, and the speaker 260 may output sound/voice. The controller 270 may control the above components to perform a unique function (for example, a wired or wireless communication or a playback of an image) of the user input processing device 200, and may calculate a direction and a position of the writing tool 100 (or the pen point 12) by measuring a magnetic field from the writing tool 100. Although a power source is not described, this component has been well known and description thereof is omitted herein. Also, description of the gyroscope 212, the accelerometer 214, the communicator 220, the display 230, the microphone 250, and the speaker 260 is omitted herein.

The magnetic field sensor 210 may be hall sensors to measure one-dimensional (1D) magnetic field values, or a two-dimensional (2D) or three-dimensional (3D) magnetometer. For example, a multi-dimensional sensor has the same effect as if the same number of 1D sensors as a number of dimensions are installed. In the present embodiment, the magnetic field sensor 210 includes a plurality of 1D magnetic field sensors, for example, 1D magnetic field sensors 210a, 210b and 210c, arranged in different directions.

The inputter 240 may be implemented as a general button or as a touch screen located on the display 230.

The user input processing device 200 may be applicable to an electrical device, for example, a tablet personal computer (PC) or a smartphone.

The controller 270 of the user input processing device 200 acquires information on a position and direction of the writing tool based on information on the sensed magnetic field and information on an input of the writing tool 100 on a touch screen and information on a position of a hand of a user, and processes the acquired information as a user input.

The information on the position of the hand includes the following information. For writing or drawing, a user rarely uses both hands, and continues to use one of the hands. In other words, a right-hander uses a right hand, and a left-hander uses a left hand. When a user is right-handed, the pen point 12 is in contact with the touch screen in an upper left side in comparison to a position in which a finger or a palm near a thumb of a right hand of the user is in contact with the touch screen during writing or drawing. Similarly, when a user is left-handed, the pen point 12 is in contact with the touch screen in an upper right side in comparison to a position in which a finger or a palm near a thumb of a left hand of the user is in contact with the touch screen during writing or drawing. During drawing or writing, the writing tool 100 held by a right-hander is inclined with respect to the touch screen in a lower right direction, and the writing tool 100 held by a left-hander is inclined with respect to the touch screen in a lower left direction, although the writing tool 100 is inclined at different angles. In other words, the information on the position of the hand (for example, writing habit information) may include a relative position of the pen point 12 based on a writing habit of a user (for example, a right-hander or a left-hander) and an angle at which the writing tool 100 is inclined.

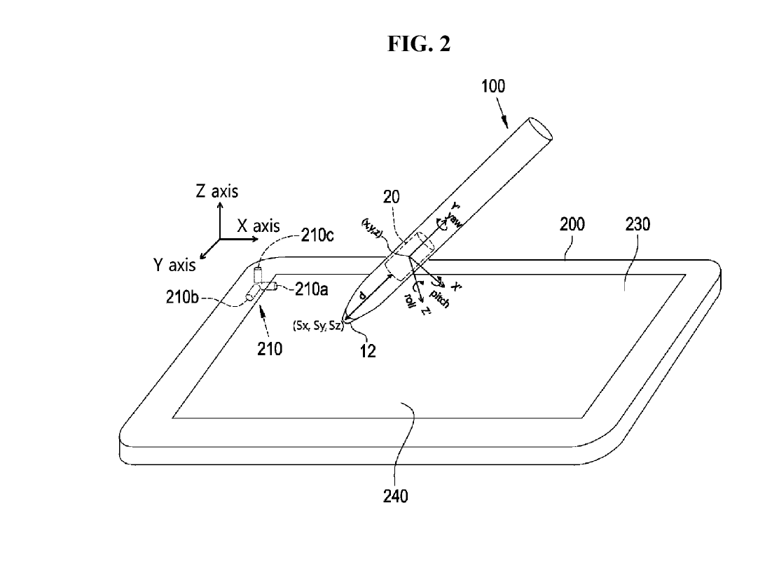

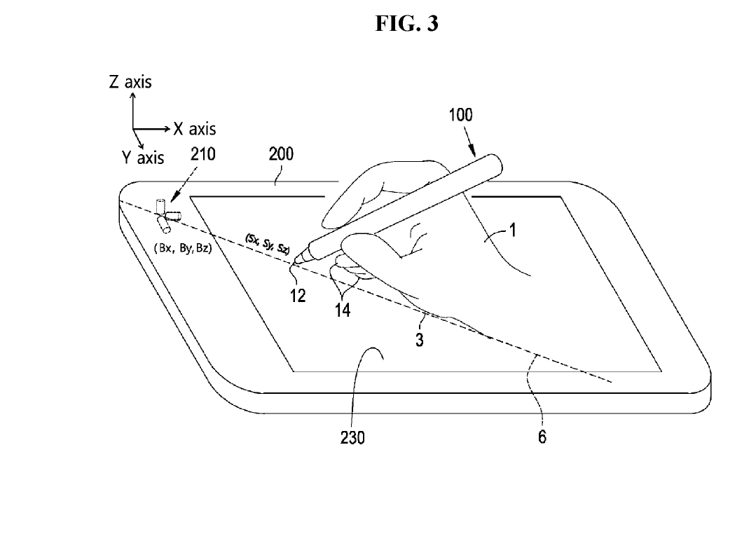

FIGS. 2 and 3 illustrate examples of using the user input processing device of FIG. 1 according to a first embodiment.

As shown in FIG. 2, the user input processing device 200, for example, most existing tablets, and the like, includes the inputter 240 that is a touch screen, and a 3-axis magnetic field sensor 210 configured to measure a 3D direction of a magnetic field of the earth for an application, for example, an augmented reality.

The controller 270 may receive, as an input, magnetic field information (for example, a magnetic field value) from the 3-axis magnetic field sensor 210 configured to measure a magnitude of magnetic fields perpendicular to each other, may process the magnetic field information, may receive, as an input, a pressing position on the touch screen using the inputter 240, and may display an output associated with a state of the user input processing device on the display 230.

The controller 270 may receive, as an input, a value of a magnetic field, for example, the magnetic field of the earth, formed by the magnetic field generator 20 from three magnetic field sensors 210 close enough to the magnetic field generator 20, and may receive, as an input, a 3D position (Sx, Sy, Sz) pressed by the pen point 12 fixed on the body portion 10 using the inputter 240. When a sufficiently large number of magnetic field sensors 210 are mounted in the user input processing device 200, a space position and direction of the magnetic field generator 20 may be verified. In particular, when sensor values may not be dependent on, that is, may be independent of each other and a number of the sensor values may be equal to or greater than a number of degrees of freedom of a position and direction of the magnetic field generator 20 and are input, a position and direction of the magnetic field generator 20 may be specified as a single position and a single direction.

For example, when the magnetic field generator 20 is a dipole magnet and when a central axis of rotation of the writing tool 100 is matched to a dipole axis Y′ of the magnet, the same difference between values of magnetic fields around the magnet as a rotationally symmetric magnetic field generated by the magnet based on the dipole axis Y′ may not be caused by a rotation yaw of the magnet and the writing tool 100 with the dipole axis Y′ as a central axis. In this example, a rotation element of the magnet may not be measured, and a position and direction of the magnet are described based on five degrees of freedom, for example, a central position (x, y, z) of the magnet, rotation angles roll and pitch about axes X′ and Z′ that are independent of the dipole axis Y′. Thus, for each time, the 3-axis magnetic field sensor 210 may read three magnetic field values set by the position and direction of the magnet, and a 3D position (Sx, Sy, Sz) in which the pen point 12 fixed with the magnet presses the touch screen at a single time, and may secure six independent sensor values obtained by 3+3=6, and accordingly it is possible to identify the position and direction of the magnet with five degrees of freedom. To this end, the controller 270 may store, as software, a nonlinear function B describing an associative relationship between magnetic field values Bx, By and Bz read by the 3-axis magnetic field sensor 210 and the position (Sx, Sy, Sz) of the pen point 12 based on the central position (x, y, z) of the magnet and the rotation angles roll and pitch. In other words, a relationship shown in Equation 1 may be formed.

B(x,y,z,roll,pitch)=(Sx,Sy,Sz,Bx,By,Bz) [Equation 1]

The controller 270 may obtain (x, y, z, roll, pitch) used to describe actual values Bx, By and Bz of the magnetic field sensor 210 and actual touch screen input values Sx, Sy and Sz read from the inputter 240, by substituting actual input values Sx, Sy, Sz, Bx, By and Bz into Equation 1 and performing a nonlinear optimization on Equation 1. In other words, the controller 270 may calculate a position and direction vector (x, y, z, roll, pitch) of the magnet in which a difference between magnitudes of signals calculated through the function B and actually measured value Sx, Sy, Sz, Bx, By and Bz is minimized based on a predetermined criterion. The controller 270 may perform a numerical analysis algorithm for obtaining a solution of an equation, in addition to the nonlinear optimization, to obtain five variable values, that is, x, y, z, roll and pitch. Also, the controller 270 may actually measure, in advance, a magnitude vector of a magnetic field signal and all position values of the touch screen to be detected by the inputter 240 by an available position and direction vector of the magnet, may generate and store table data, and may search for, from the table data, an actual value detected by the magnetic field sensor 210 and a value that is the closest to (that is best correspond to) a touch input value, to obtain (x, y, z, roll, pitch) corresponding to the value or interpolate several candidate variables.

When a specific position (Sx, Sy, Sz) of the pen point 12 on the touch screen is known through the inputter 240, a variable describing a position and direction of a magnet fixed with the pen point 12 while a predetermined distance d between the magnet and the pen point 12 is maintained may be reduced to 2D below. Because the rotation component yaw of rotation of the writing tool 100 about the body portion 10 does not have meaning due to a rotationally symmetric magnetic field, both an exact position and an exact direction of the magnet in 3D may be known when two variables, that is, an angle theta between a center of the writing tool 100 (that is, a center of a magnet) and a normal line of the touch screen and an angle phi between an X axis of the touch screen and a projection of the writing tool 100 onto the touch screen, are known. In this example, a position of the magnet in a space may be changed by the two variables, that is, the angles theta and phi, and accordingly a magnetic field value read by the magnetic field sensor 210 may change. Thus, a function B′ describing an associative relationship between the angles theta and phi and the magnetic field value sensed by the magnetic field sensor 210 may be easily induced from data or an equation describing how to form a magnetic field value in a space.

B′(theta,phi)=(Bx,By,Bz) [Equation 2]

The controller 270 performs a nonlinear optimization by substituting Bx, By, Bz that are actually measured x-, y- and z-axis magnetic field values into Equation 2, and calculates the angles theta and phi. Accordingly, a five-dimensional (5D) problem of Equation 1 is simplified to a 2D problem of Equation 2.

Because the two values, that is, the angles theta and phi need to be known, both the angles theta and phi may be calculated using two independent magnetic field sensors 210 without a need to use all the three magnetic field sensors 210. When writing software is executed by the user input processing device 200, various 3D effects or an effect as if ink actually spreads on paper, for example, controlling and displaying of a position of a stroke displayed on the display 230 and a width or brightness and cursiveness (for example, a visual feature) of a drawn stroke based on a position of the pen point 12 and the angles theta and phi formed between the body portion 10 and the touch screen, or a manipulation for a 3D object displayed by software based on the angles theta and phi.

Also, the controller 270 enables an input by the writing tool 100 to correspond to erasing instead of drawing a stroke, in response to a user touching a touch screen by allowing the writing tool 100 to face upwards (for example, vertically standing the writing tool 100) during wiring, unlike information (for example, the angles theta and phi during writing) on a general position of the writing tool 100 used by the user. The controller 270 performs a function of automatically changing the input by the writing tool 100 to a marker in response to the writing tool 100 held by a right hand being inclined to a left side or in response to the writing tool 100 held by a left hand being inclined to a right side. In other words, the controller 270 processes input values of the touch screen using different schemes based on writing habit information of the user.

In the above description, it is assumed that only the magnet of the writing tool 100 has an influence on the magnetic field sensor 210 or all magnetic fields having an influence on the magnetic field sensor 210 in addition to the magnet are known. However, in addition to an influence by the magnet 20 of the writing tool 100, a magnetic field value of a magnetic field sensor is determined by the following environmental factors:

1) Offset O: a sensor value is read as an arbitrary positive or negative offset value other than “0” due to an electrical characteristic of the magnetic field sensor 210, and a value obtained by adding up the above value with an applied magnetic field value is read later, every time a voltage starts to be applied to the magnetic field sensor 210 in response to the user input processing device 200 being powered on even though a neighboring magnetic field does not exist.

2) Internal magnet I: magnetic field I applied in a magnet included in the user input processing device 200: a constant magnetic field may be applied to the magnetic field sensor 210 by a magnet mounted in, for example, the speaker 260 of the user input processing device 200.

3) Magnetic field G of the earth: as a magnetic field by the earth applied to all positions in the earth, a magnetic field is applied with the same magnitude and direction regardless of a position in the user input processing device. In addition, by a ferromagnetic substance located far enough away from the user input processing device, a magnetic field applied with substantially the same magnitude and direction regardless of a position in the user input processing device is assumed to be added to G.

When a magnet located outside the user input processing device 200 is close to a sensor, magnetic fields with different magnitudes or directions may be applied in each position of the user input processing device 200. However, because this is a rare case and a user may remove the magnet, it is assumed that the magnet does not exist. Among the above three factors, the factors O and I remain unchanged regardless of a movement of the user input processing device 200, whereas the factor G changes based on a change in an angle at which the magnetic field of the earth is applied to the user input processing device 200, and accordingly an entire applied ambient magnetic field value (hereinafter, represented by “E”) may change.

When the user input processing device 200 is fixed in a single position on the earth and does not move, an ambient magnetic field E=(Ex, Ey, Ez) formed by a neighboring permanent magnet and the magnetic field of the earth may not change in most cases. When a change in a magnetic field due to noise and the like is ignored, the ambient magnetic field E may be regarded as a constant. Accordingly, in a state in which a user places the writing tool 100 far enough away from the magnetic field sensor 210 before using the writing tool 100 on the user input processing device 200, when the controller 270 measures the ambient magnetic field (Ex, Ey, Ez) using the magnetic field sensor 210 and the user input processing device 200 is used in the same position, the controller 270 may calculate a position and direction of the writing tool 100 and the magnet that are moving, because a magnetic field value affected by the magnet of the writing tool 100 is obtained by subtracting the measured ambient magnetic field (Ex, Ey, Ez) from a value of the magnetic field sensor. In addition, when a position and direction of a dipole of a magnet is not matched to a rotation axis Y′ of the writing tool 100 (for example, when a central point of the magnet is on the rotation axis Y′ of the writing tool 100 and the direction of the dipole forms an angle close to a right angle with the rotation axis), the controller 270 may calculate the rotation component yaw of the writing tool 100, together with the angles theta and phi. However, a strength of a magnet may not be sufficiently constant in manufacturing of the writing tool 100. In this example, the controller 270 may notify a user that the writing tool 100 forms a specific angle, for example, a right angle, with the user input processing device 200 in a specific position of the user input processing device 200, using the display 230 or the speaker 260, and may additionally perform a calibration process of measuring a value of the magnetic field sensor 210 and measuring a strength constant of the magnet based on the measured value.

When the dipole of the magnet is disposed in the same direction as a rotation axis of the body portion 10 as described above, six measurement values (for example, Sx, Sy, Sz, Bx, By and Bz, and include three values by the touch screen and three values by a 3-axis magnetic field sensor) which indicates that a single value remains after a position of the writing tool 100 having five degrees of freedom at each time may be obtained. Accordingly, a unknown ambient magnetic field (Ex, Ey, Ez) may be calculated based on a single sensor value remaining at each time, even though an artificial calibration process of measuring the ambient magnetic field (Ex, Ey, Ez) by placing the writing tool 100 apart from the user input processing device 200 is not performed. In particular, because three values, that is, Ex, Ey, Ez are unknown, the controller 270 may obtain ambient magnetic field values Ex, Ey and Ez from values of a magnetic field sensor and input values of the touch screen measured at three times. This is a problem of obtaining values of nine variables, for example, six variables corresponding to pairs of angles theta and phi (theta1, phi1), (theta2, phi2) and (theta3, phi3) at three times and three variables that are ambient magnetic field values Ex, Ey and Ez remaining unchanged within a period of the three times using an equation associated with nine values in total, that is, three magnetic field sensor values (Bx1, By1, Bz1), (Bx2, By2, Bz2) and (Bx3, By3, Bz3) obtained at each of three times, and the controller 270 may calculate nine variable values through a nonlinear optimization using nine equations.

Also, the controller 270 may estimate an exact value of the ambient magnetic field (Ex, Ey, Ez) from a sensor value (Bx, By, Bz) measured at multiple times at which the pen point 12 in contact with the touch screen moves by a stroke arbitrarily drawn by a user, using a parameter fitting scheme and the like. The estimating of (Ex, Ey, Ez) is required when a discontinuous value of the magnetic field sensor 210 is adjusted due to an internal calibration of an operating system of the user input processing device 200 and when an ambient magnetic field changes due to a movement of a computer in a space, as well as when a user starts to use the writing tool 100 as described above. In this example, when the user touches, using the writing tool 100, three arbitrary points that are sufficiently spaced apart on the touch screen, or draws a single stroke, an equation including the above-described ambient magnetic field (Ex, Ey, Ez) as a variable may be solved or obtained using the parameter fitting scheme by measuring a value of a magnetic field sensor and coordinates of the touch screen in at least three pen positions sufficiently spaced apart and measured.

The user input processing device 200 includes the gyroscope 212 or the accelerometer 214 in addition to the touch screen and the magnetic field sensor 210. When the gyroscope 212 or the accelerometer 214 senses that an orientation angle of the user input processing device 200 changes above a predetermined value, the controller 270 may request a user to perform an action (for example, writing by at least a predetermined length in a state in which the writing tool 100 is in contact with the touch screen) of drawing a sufficiently long stroke on the touch screen until a new ambient magnetic field (Ex, Ey, Ez) is estimated or known, and may calculate an ambient magnetic field (Ex, Ey, Ez) from values of a magnetic field sensor and the touch screen obtained at at least three times while the stroke is drawn. When the orientation angle of the user input processing device 200 is determined to change or a change in a value of the magnetic field sensor 210 due to an internal calibration, and the like is sensed, during writing, that is, while the user uses a pen, the controller 270 may collect a touch position and a magnetic field sensor value of each time until estimation of a value of a new ambient magnetic field (Ex, Ey, Ez) is enabled in response to reception of at least three input values of the touch screen sufficiently spaced apart, and may update a value of an ambient magnetic field, instead of requesting a separate action of drawing a stroke. During a period of time in which the estimation is not enabled, the controller 270 may store a value read by the magnetic field sensor 210, may wait until the estimation is enabled, and may display a stroke with a predetermined width on a touch position of the touch screen. When the estimation is enabled, the controller 270 may calculate angles theta and phi that have not been calculated, may change a width of an already drawn stroke based on the angles theta and phi, and may display the stroke on the display 230.

Because the same ambient magnetic field (Ex, Ey, Ez) is assumed during a relatively short period of time in most cases unless the orientation angle of the user input processing device 200 is rapidly changed, the controller 270 may continue to estimate the ambient magnetic field (Ex, Ey, Ez) using the parameter fitting scheme and the like, and may calculate the angles theta and phi, that is, variables changed in the user input processing device 200 of which the orientation angle is changed.

As described above, the user input processing device 200 further includes the general-purpose magnetic field sensor 210 for measuring a direction, the gyroscope 212 that is a rotation accelerometer, and the linear accelerometer 214, to continue to measure a change in a direction in which the user input processing device 200 faces by rotation of the user input processing device 200 in a state of a gravity. When a user uses the writing tool 100 including the magnet 20 for writing while holding and moving the user input processing device 200, the controller 270 may distinguish a earth component (=G) fixed outside a device from an onboard component (=O+I) that is fixed with the magnetic field sensor 210 and that has a constant influence on the magnetic field sensor 210 regardless of a direction in which the user input processing device 200 moves in the ambient magnetic field E, and may measure the earth component and onboard component, by performing a calibration process of measuring, in advance, a magnitude of the ambient magnetic field E to reflect a value of an ambient magnetic field changed based on a change in the orientation angle of the user input processing device 200. To this end, various electronic compass calibration algorithms according to the related art may be used to distinguish the earth component from the onboard component through a sensor fusion of values measured by a magnetic field sensor, an accelerometer and a gyroscope in the user input processing device 200 while swinging the user input processing device 200 in a figure of eight in a space. The onboard component is a value obtained by adding a component applied by a magnet installed in the user input processing device 200 and an arbitrarily electrical offset value generated by the above-described characteristic of the magnetic field sensor, and the earth component is a component applied by a magnet fixed outside and the magnetic field of the earth. Because it is difficult to obtain directions of north, south, east and west of the user input processing device 200 in an earth coordinate system using the magnetic field sensor 210 due to an interference by the magnet 20 while the writing tool 100 approaches the touch screen and is used after the calibration, a scheme of rotating the user input processing device 200 in a neighboring coordinate system may be estimated from a visual sensor, for example, a depth sensor, a camera, or a fusion of the gyroscope 212 and the linear accelerometer 214, except the magnetic field sensor 210, the earth component may be corrected in the same times as a number of rotations of the user input processing device 200, a constant onboard component may be added regardless of the rotation of the user input processing device 200, and a value obtained by adding the earth component and the onboard component may be stored and used as a current ambient magnetic field value of the user input processing device 200. Thus, an exact ambient magnetic field value may continue to be obtained despite a change in a direction of a neighboring magnetic field applied to the user input processing device 200 due to a movement of the user input processing device 200.

In addition, a soft iron effect by a ferromagnetic substance adjacent to a sensor has an influence on the magnetic field sensor 210. The soft iron effect acts as a scale factor of each sensor axis. To prevent a malfunction of the user input processing device 200 based on both the soft iron effect and the above-described ambient magnetic field E, calibration may be performed at least two positions. For example, when an actual magnetic field component applied by a magnet of a pen to the magnetic field sensor 210 corresponds to the values x, y and z calculated by Equation 1, magnetic field values x+Ex, y+Ey, z+Ez may be sensed by the magnetic field sensor 210 due to the above-described ambient magnetic field, and magnetic field values a×x+E′x, b×y+E′y, c×z+E′z may be finally sensed due to the soft iron effect. (Each of Ex, E′y and E′z, as a constant, includes a value of the magnetic field G of the earth changed by the soft iron effect and a value of the magnetic field I by the internal magnet, and is set by adding an arbitrary offset O due to a characteristic of the above-described sensor.) In other words, the controller 270 needs to calculate scale factors a, b and c to be added, in addition to E′x, E′y and E′z. The controller 270 may secure six magnetic field values in total, that is, 3-axis magnetic field values actually measured twice by performing the calibration at two positions, and may calculate six factor values including the scale factors a, b and c and E′x, E′y and E′z.

For calibration of various magnetic field components, when the writing tool 100 is located far away from the user input processing device 200 (for example, by at least a predetermined distance) based on a direction and position of the writing tool 100, a magnetic field component (x, y, z)=(0, 0, 0) indicating that the magnet 20 has an influence on the magnetic field sensor 210 is satisfied. To this end, the controller 270 may notify a user to move the writing tool 100 to a position far away from the user input processing device 200 while using the writing tool 100. In the above process, the controller 270 may perform calibration. Also, instead of performing the calibration when a single writing tool 100 is placed in different positions, the controller 270 may acquire magnetic field values when a single writing tool 100 is located first, and may calculate six factor values by processing, using a scheme similar to the above-described scheme, additional magnetic field values acquired when an additional writing tool is disposed in a position that is different from the position of the writing tool 100 and that is spaced apart from the position of the writing tool 100 by at least a reference distance. The obtained scale factors may be applied when an onboard ferromagnetic substance is attached to the user input processing device 200 and moves together with the user input processing device 200, or may be applied while an input by the writing tool 100 is processed when a ferromagnetic substance is located close to a sensor outside the user input processing device 200 and when the user input processing device 200 does not move. This is because the scale factors a, b and c may change when the ferromagnetic substance is located outside the user input processing device 200 and the user input processing device 200 moves.

To correct a soft iron effect by an external ferromagnetic substance when the user input processing device 200 moves, or to correct a soft iron effect without a separate calibration, a number of magnetic field sensors greater than a number of degrees of freedom of the writing tool 100 may be used, magnetic field values input in a changed position of the writing tool 100 measured at multiple times may be collected, and factors may be obtained by using parameter fitting or solving simultaneous equations of multiple times as described above. For example, when a 3-axis magnetic field sensor is used, a 3-axis magnetic field value may be read while a to user touches the touch screen using the writing tool 100, and three actually measured values may be stored for each time. Because two variables (for example, theta and phi) are changed at each time as described above, and six factors, for example, E′x, E′y, E′z, a, b and c are unknown, “3×6” magnetic field sensor values may be collected during a period of six times, and 18 simultaneous equations obtained by 18 sensor values for 18 unknowns in total, six variables (including theta, phi) during the period of six times, and six unknown factors may be solved. In this example, there is a need to assume that scale factors have substantially the same values because the user input processing device 200 hardly moves during the period of six times. In addition to directly solving of the simultaneous equations as described above, it is obvious that a parameter value may be obtained by parameter fitting under the assumption that parameters Ex, E′y, E′z, a, b and c remain unchanged for magnetic field sensor values obtained at multiple times. Also, an assumption that values of theta and phi remain unchanged may be additionally applied.

For example, when a soft iron effect for the writing tool 100 that is floating needs to be corrected, at least six sensors may be required because of the five degrees of freedom (x, y, z, roll and pitch in Equation 1) of the writing tool 100. A total of 12 factor values are unknown because of two factor values, for example, E′i and Scale_factor_i for each sensor Si. Accordingly, the controller 270 may collect six-axis sensor values at a total of 12 times and may solve 72 simultaneous equations. For example, when a number of sensors is greater by “1” than a number of degrees of freedom of the writing tool 100, a number of times to solve simultaneous equations may be reduced by “1”. Also, scale_factor_i that needs to be calculated is the same as the number of sensors, however, an independent value of an ambient magnetic field factor E′i needs to be obtained for each sensor because onboard values by an internal magnet and an arbitrary sensor offset need to be obtained. Onboard is a constant, and only an earth value determined by an angle of three degrees of freedom that is a direction in which the user input processing device 200 is oriented in 3D needs to be calculated, and accordingly a number of times to calculate factor values may be reduced. Also, a change in the direction of the three degrees of freedom in which the user input processing device 200 is oriented may be calculated based on a value of a gyroscope mounted in the user input processing device 200, and accordingly a change in the earth value may be measured. A single factor scale_factor_i needs to be calculated for each sensor, and thus it is possible to correct the soft iron effect by using parameter fitting or solving simultaneous equations from sensor values during a relatively short period of time.

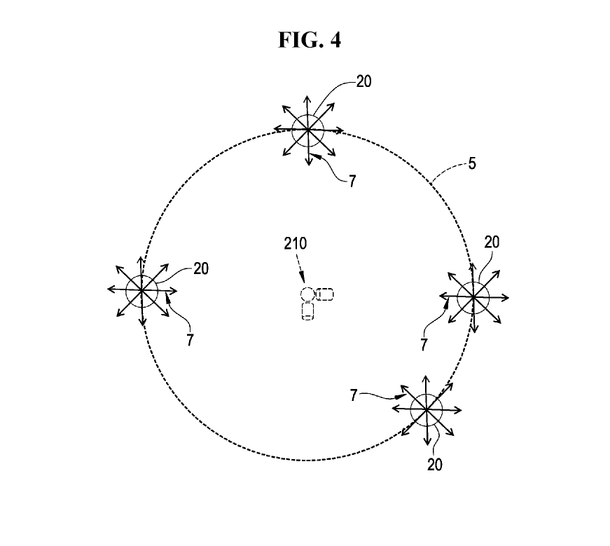

FIG. 3 illustrates a second example of using the user input processing device of FIG. 1, and FIG. 4 illustrates an example in which a magnetic field sensor located on a center of a circle senses a magnetic field when a magnet is located on a circumference. In most smartphones and tablets according to the related art, touch screens includes, for example, capacitive touch screens, static pressure touch screens and optical touch screens, and it is impossible to distinguish a touch by the pen point 12, a touch by a palm 3 near a thumb or a touch by a finger 14 and all the touches are recognized as the same touch input value. In other words, unlike actually writing on paper, only a fingertip or the pen point 12 needs to be in contact with a touch screen while a user raises a hand 1, which causes the user to feel inconvenience in use and a difficulty in exactly writing. As described above, when a value of the 3-axis magnetic field sensor 210 is used and when a dipole of the magnet is matched to a direction of a rotation axis of the body portion 10, the controller 270 may utilize a single extra magnetic field sensor 210 other than two magnetic field sensors 210 required to find out the angles theta and phi of the magnet. Thus, “writing with a raised hand” on the touch screen (for example, palm resting or palm rejection) may be implemented using the extra magnetic field sensor 210.

For example, when an extension line of the dipole of the magnet spaced apart by a known constant d in a direction from a touch position (Sx, Sy, Sz) input through the touch screen and known in an inclination direction at angles theta and phi with respect to the touch screen passes through the touch position (Sx, Sy, Sz), the controller 270 may determine whether magnetic field values Bx, By and Bz actually measured by three magnetic field sensors 210 are detectable at the same time as the touch input. The controller 270 may perform a nonlinear optimization to find the angles theta and phi from the touch position (Sx, Sy, Sz) and values Bx, By and Bz read by the magnetic field sensors 210 or other algorithms to obtain a solution, may determine that it is impossible to calculate the angles theta and phi or may obtain values of the angles theta and phi beyond a possible reference range due to a mechanical property of a pen. In this example, the controller 270 may determine that a touch at the touch position (Sx, Sy, Sz) is not a touch by the pen point 12. When the values of the angles theta and phi are within a reasonable range, the controller 270 may determine that the touch position (Sx, Sy, Sz) corresponds to the to touch by the pen point 12 (for example, a touch intended by a user). As described above, for example, the controller 270 may compare a direction or magnitude of a magnetic field read by the 3-axis magnetic field sensor 210 to a direction or magnitude of a magnetic field that may be detected when the writing tool 100 (or the magnet) is in a direction of the angles theta and phi within a reference range. When the directions and magnitudes are different from each other by at least a predetermined value as a result of the comparing, a touch by a hand other than the pen point 12 may be determined. Based on the determination, the controller 270 may draw a stroke on the display 240 in a position determined as a touch by the writing tool 100, and may ignore an input corresponding to a position determined not to be the touch by the writing tool 100, to implement “writing with a raised hand” of a user (for example, palm rejection). Also, the controller 270 may distinguish a touch by the hand 1 from a touch by the writing tool 100, and may control different types of software operations to be performed. The distinguishing may be performed at a single time, and may be applied to values of a single stroke (for example, a trajectory continuously drawn from a touch on the touch screen) measured at several times to further increase accuracy. When an algorithm to distinguish touches for a single stroke is performed, the controller 270 may use various distinguishment schemes, for example, determining of a touch as a touch by the writing tool 100 when the angles theta and phi have reasonable values for all points of a stroke, or determining of a touch as a touch other than the touch by the writing tool 100 (or the pen point 12) when the angles theta and phi rapidly change at a reference speed or higher.

However, when a ferromagnetic substance, for example, a concentrator, is included in the magnetic field sensor 210 to change a direction of a sensed magnetic field based on a type of magnetic field sensors 210, or when a ferromagnetic substance, for example, iron is used to support an external appearance of a computer close to a sensor, a ferromagnetic substance adjacent to the sensor may be magnetic due to a magnetic hysteresis in response to a magnet moving closer to and away from the magnetic field sensor 210, which may cause a problem in that a magnetic field different from an ambient magnetic field is applied to the magnetic field sensor 210. In addition, due to a neighboring AC power line, and the like in a very close position, noise may occur by, for example, a magnetic field generated by the power line, which may cause an occurrence in an error in a sensor value. Due to the error, it is impossible to accurately measure only a magnetic field applied by the magnet installed in the writing tool 100.

In this example, the controller 270 may use information on an angle of a pointing device determined based on whether a user is right-handed or left-handed during writing.

When a central point of the magnet 20 is located on a circumference 5 including points at the same distance with the magnetic field sensor 210 and a dipole of the magnet 20 is disposed in a direction substantially perpendicular to a plane of the circumference as shown in FIG. 4, a magnetic field with the same direction and the same magnitude is sensed by the magnetic field sensor 210 by a rotationally symmetric magnetic field 7 applied by the magnet regardless of a position of the magnet 20 that is one of points on the circumference 5. Due to the above rotationally symmetric property of the magnetic field generated by the magnet 20, it is difficult to determine, based on a value of a magnetic field sensor, which one of a touch by the pen point 12 and a touch by a hand 1 in similar distances with the magnetic field sensor 210 on the touch screen is a touch by the writing tool 100 including the magnet 20. In particular, in a situation in which the above-described noise occurs, it may be further difficult to perform the determining.

To solve the above problems, the magnetic field sensor 210 may be installed in a position in which a difference between a gap (that is, a distance) between a touch position by the pen point 12 and the magnetic field sensor 210 and a gap (that is, a distance) between a touch position by the hand 1 and the magnetic field sensor 210 is maximized. When relative directions of the writing tool 100 and the hand 1 are arbitrarily set, an optimum position of the magnetic field sensor 210 may not be limited, however, a position of the magnetic field sensor 210 may be determined based on a property that a constant relative direction between the hand 1 and the pen point 12 is set to an upper left-lower right direction based on whether a user is right-handed or left-handed during writing, as described above.

For example, when a user is right-handed as shown in FIG. 3, the pen point 12 is located in an upper left side in comparison to a touch position 3 of the hand 1, and accordingly the magnetic field sensor 210 may be disposed as close to a line 6 as possible. The line 6 connects the pen point 12 and the touch position 3 of the hand 1 in a direction from an upper left end to a lower right end of the user input processing device 200. In other words, the magnetic field sensor 210 may be disposed to be maximally close to a straight line connecting the magnet 20 mounted in the writing tool 100 and the palm 3 of the hand 1 in contact with the touch screen. A difference in a magnetic field having an influence on the magnetic field sensor 210 between a touch by the hand 1 and a touch by the writing tool 100 may be maximized, and thus the controller 270 may accurately determine whether a single touch is the touch by the hand 1 or touch by the writing tool 100. Similarly, when a user is left-handed, the magnetic field sensor 210 may be disposed to be close to a line drawn from an upper right side to a lower left side.

In an example of a right-hander, the writing tool 100 may be inclined to a lower right side of the touch screen, and accordingly an angle phi may be highly likely to be close to 45 degrees in a clockwise direction from an x axis of the touch screen and may be expected to be within a first reference range of 0 degrees to 90 degrees in most cases. An angle theta, that is, a degree by the writing tool 100 is inclined may be within a second reference range of about 30 degrees to 45 degrees from a normal vector of a touch screen 22, instead of having an arbitrary value. When the angles phi and theta are within the first reference range and the second reference range for each touch, respectively, by applying information on a position of each of a writing tool and a hand of a user, the controller 270 may determine whether magnetic field values Bx, By and Bz actually measured by the magnetic field sensor 210 are applied by the magnet 20 in the writing tool 100, or may determine that a probability of the touch by the writing tool 100 becomes higher when a magnetic field value applied to (or stored in) the magnetic field sensor 210 and a value actually measured by the magnetic field sensor 210 become closer to each other in a position in which the angles phi and theta are expected to be 45 degrees and 30 degrees. The controller 270 may notify a user, using the display 230, that the user naturally holds and uses the writing tool 100 so that the angles phi and theta of the writing tool 100 are within the first reference range and the second reference range, and may also notify, in advance, the user of a possibility of failing to perform a function of writing by putting a hand in other circumstances.

A portable computer system (hereinafter, referred to as a “tablet”), for example, a tablet or smartphone according to the related art includes 1) a general-purpose 3-axis magnetic field sensor to measure a direction, 2) a touch screen, and 3) an acceleration sensor, and has a function of analyzing a direction in which a user is holding the portable computer system with respect to a direction of gravity measured by the acceleration sensor and of automatically changing a software display direction with respect to a display (for example, a screen) of hardware so that an upper portion of software displayed on a display (for example, a screen) is opposite to the direction of gravity. To distinguish a pen from a hand on the touch screen using the above portable computer system and the writing tool 100 including the magnet 20, when a user changes a software display direction by holding the portable computer system (for example, a user input processing device), the controller 270 may request the user to move the magnetic field sensor 210 to a position that may facilitate distinguishing of the pen from the hand, through the display 230 or the speaker 260. In other words, the controller 270 may instruct the user to rotate a computer so that the 3-axis magnetic field sensor 210 may be located in an upper left side or a lower right side based on the user, when the user is right-handed, and may instruct the user so that the magnetic field sensor 210 may be located in an upper right side or a lower left side, when the user is left-handed.

Generally, the controller 270 may transmit, to a user, an instruction to dispose the 3-axis magnetic field sensor 210 to be closest to a line connecting the magnet 20 mounted in the writing tool 100 and a portion of the hand 1 holding the writing tool 100 in contact with the touch screen, to increase accuracy. For example, when a tablet, that is, the user input processing device 200 has a quadrilateral shape, a user may incline the tablet and hold and use the tablet so that an upper side of a screen (for example, a display) may correspond to one of four sides of the tablet. In this example, the controller 270 may instruct the user to rotate the tablet so that a side that allows the magnetic field sensor 210 to be in the closest position to a line connecting the magnet 20 and a portion of the hand 1 in contact with the screen corresponds to the upper side, to use a function of “writing with a raised hand.”

Even though information on whether a user is right-handed or left-handed does not exist, the controller 270 may determine one of touches that quickly occur at two positions on the touch screen and that overlap in time or have a difficulty in physically moving as a touch by the writing tool 100, and determine the other as a touch by the hand 1. However, when it is difficult to distinguish a touch by a pen from a touch by a hand by a magnetic field when the two positions are spaced apart by similar distances from the magnetic field sensor 210, the controller 270 may notify the user of rotation of the user input processing device 200 in a desired direction to use the function of “writing with a raised hand.”

The desired direction may be determined based on a position of the magnetic field sensor 210 installed in the user input processing device 200 and whether the user is right-handed or left-handed. Accordingly, the controller 270 may analyze an installation position of the magnetic field sensor 210 or read a stored installation position based on a model ID of the user input processing device 200, may display a user interface allowing the user to input whether the user uses a right hand or a left hand, and may analyze and store a writing habit of the user based on a user input.

When the magnetic field sensor 210 is installed in a center of the touch screen of the user input processing device 200, the controller 270 may easily perform the function of writing with a raised hand, using a single magnetic field sensor. However, because a thickness of the user input processing device 200 may increase in most cases, the magnetic field sensor 210 may not be installed below the touch screen. In this example, two 3-axis magnetic field sensors 210 may be installed near both corners of a single side of the user input processing device 200, respectively, and accordingly writing by putting a hand may be accurately implemented regardless of a direction, for example, a vertical direction or horizontal direction, of a tablet to be used by both a right-hander and a left-hander. When a plurality of magnetic field sensors 210 exist, the controller 270 may perform writing by putting a hand based on a value of a magnetic field sensor in the closest position to a line connecting the magnet 20 to a portion of the hand 1 in contact with the touch screen among the magnetic field sensors 210.

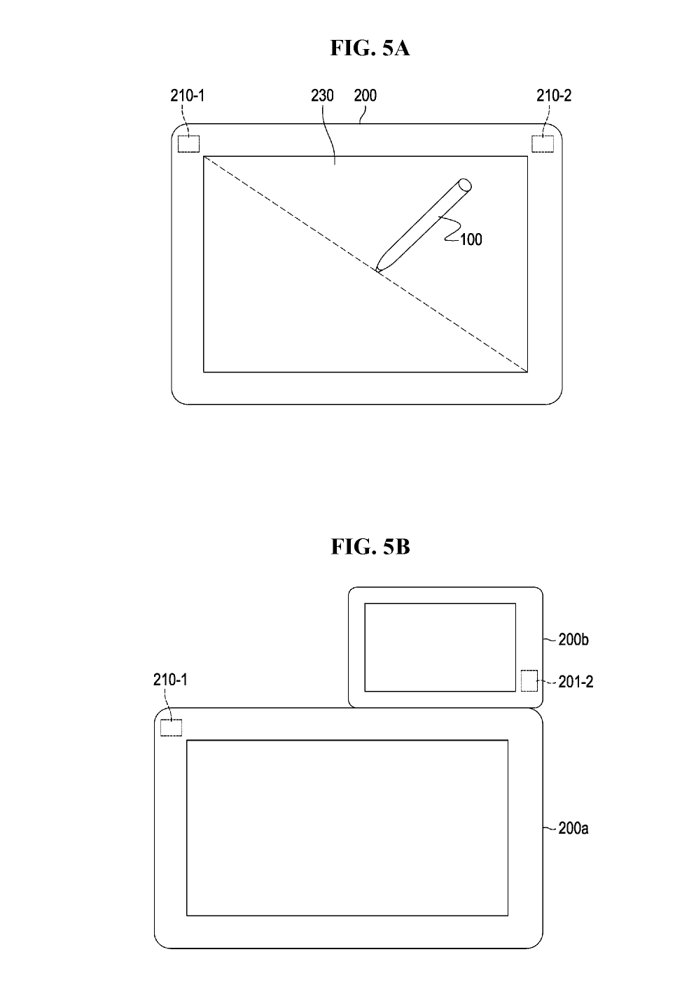

FIGS. 5A and 5B illustrate examples of the user input processing device of FIG. 1 using the 3-axis magnetic field sensor according to a third embodiment and a fourth embodiment. Unlike the above-described embodiments, in the writing tool 100 according to the present embodiment, the dipole of the magnet 20 is not matched to a rotation axis of a pen and is installed to be perpendicular to the rotation axis so that a north (N) pole and a south (S) pole are set in a diameter direction of a writing tool. Accordingly, a rotation component of the pen may also be verified. Also, for simplification of description, it is assumed that there is no soft iron effect due to a ferromagnetic substance close to a sensor.

When a pair of a first magnetic field sensor 210-1 and a second magnetic field sensor 210-2 of three axis (or three single axes) are spaced apart by a predetermined gap on both corners of a single side of the user input processing device 200 as shown in FIG. 5A, one of the magnetic field sensors may be located on a line drawn from an upper left end (or an upper right end) to a lower right end (or a lower left end) at all times in an example of a right-handler (or a left-handler). Thus, writing by putting a hand may be implemented regardless of which one of sides of the user input processing device 200 (for example, a tablet, and the like) corresponds to an upper side of the display 230 (for example, a screen). Also, there is no need to perform calibration to analyze an ambient magnetic field every time the user input processing device 200 moves, by using the following method.

A magnetic field S1 sensed by the first magnetic field sensor 210-1 may be represented as shown in Equation 3 below.

S1=earth1+onboard1+B1(theta,phi,alpha) [Equation 3]

Here, a vector earth1 is a magnetic field component fixed outside a user input processing device by the magnetic field of the earth, and the like, as described above, and onboard1 is an arbitrary electrical offset value of the first magnetic field sensor 210-1 and a magnetic field value applied by a magnet fixed in the user input processing device and may be marked for each component as onboard1x, onboard1y and onboard1z based on use of a 3-axis sensor. A vector B1 is a magnetic field value by the magnet 20 and corresponds to B1x(theta, phi, alpha), B1y(theta, phi, alpha) and B1z(theta, phi, alpha), and alpha denotes a degree (for example, yaw of FIG. 2) by which the writing tool 100 of which a dipole is installed in a rotation direction rotates about a rotation axis.

A magnetic field S2 sensed by the second magnetic field sensor 210-2 may be represented as shown in Equation 4 below.

S2=earth2onboard2+B2(theta,phi,alpha) [Equation 4]

Here, a vector earth2 is a magnetic field component fixed outside a user input processing device by the magnetic field of the earth, and the like, as described above, and onboard2 is an arbitrary electrical offset value of the second magnetic field sensor 210-2 and a magnetic field value applied by a magnet fixed in the user input processing device and may be marked for each component as onboard2x, onboard2y and onboard2z based on use of a 3-axis sensor. A vector B2 is a magnetic field value by the magnet 20 and corresponds to B2x(theta, phi, alpha), B2y(theta, phi, alpha) and B2z(theta, phi, alpha).

Because offset values are changed to arbitrary values that are unknown in advance every time an internal circuit is electrically greatly changed during powering on/off of the user input processing device 200, and remain unchanged in the other circumstances, the controller 270 may calculate and store a value of “onboard2−onboard1” during initial calibration, for example, moving the writing tool 100 away from the user input processing device 200. Because the first magnetic field sensor 210-1 and the second magnetic field sensor 210-2 are sufficiently close to each other, the vectors earth1 and earth2 as values of the magnetic field of the earth are substantially the same. When a small and strong electromagnet or iron, instead of the writing tool 100, is located close to the user input processing device 200, values of E may be different in the first magnetic field sensor 210-1 and the second magnetic field sensor 210-2. However, in many cases, it may be assumed that the user input processing device 200 is not in the above environment. The controller 270 may allow the vectors earth1 and earth2 to disappear by subtracting a vector S1 from a vector S2, which may be represented as shown in Equation 5 below.

$$S 2 - S 1 = ( S 2 x - S 1 x , S 2 y - S 1 y , S 2 z - S 1 z ) = ( onboard 2 x - onboard 1 x + B 2 x ( theta , phi , alpha ) - B 1 x ( theta , phi , alpha ) , onboard 2 y - onboard 1 y + B 2 y ( theta , phi , alpha ) - B 1 y ( theta , phi , alpha ) , onboard 2 z - onboard 1 z + B 2 z ( theta , phi , alpha ) - B 1 z ( theta , phi , alpha ) ) \qquad [ Equation 5 ]$$

As shown in Equation 5, (onboard2x−onboard1x), (onboard2y−onboard1y) and (onboard2z−onboard1z) are constants measured in advance during calibration even though the user input processing device 200 moves. Because three 3D equations are derived for variables theta, phi and alpha, the controller 270 may calculate the variables theta, phi and alpha. Thus, the controller 270 may calculate a direction and position of a writing tool from a magnetic field value of the magnet 20 during writing, instead of needing to perform separate calibration even though the user input processing device 200 moves.

Also, the first magnetic field sensor 210-1 and the second magnetic field sensor 210-2 do not need to be mounted in the same electrical device. As shown in FIG. 5B, the first magnetic field sensor 210-1 may be located in a first user input processing device 200a, and a second user input processing device 200b including the second magnetic field sensor 210-2 may be spaced apart by a predetermined distance on the same straight line as the first magnetic field sensor 210-1. The second user input processing device 200b may transmit an offset value and a magnetic field value of the second magnetic field sensor 210-2 to the first user input processing device 200a, and the first user input processing device 200a may receive the offset value and the magnetic field value using a communicator and may determine a position and direction of a writing tool by applying the above-described Equations 3 through 5.

When a sufficient number of magnetic field sensors is not included unlike the example of FIG. 5A, the controller 270 needs to separately know an ambient magnetic field (Ex, Ey, Ez) to measure only a magnetic field applied to the magnetic field sensor 210 by the magnet 20. When the writing tool 100 starts to be used, when the user input processing device 200 moves, or when a value of the magnetic field sensor 210 rapidly changes due to an internal reason, the ambient magnetic field (Ex, Ey, Ez) may need to be obtained from points at which a plurality of touches occur and that are sufficiently spaced apart, as described above. In a time interval in which the ambient magnetic field (Ex, Ey, Ez) is unknown, the controller 270 may display all strokes drawn by all touches including a touch by the writing tool 100 and a touch by the hand 1 on the display 230 until the ambient magnetic field (Ex, Ey, Ez) is obtained, and may store a magnetic field sensor value at each point. When the ambient magnetic field (Ex, Ey, Ez) is analyzed from at least three touch positions, the controller 270 may calculate a magnetic field value applied by the magnet 20 of the writing tool 100 by subtracting the analyzed ambient magnetic field (Ex, Ey, Ez) from a magnetic field sensor value measured and stored in a time during which each point of each of the strokes is drawn. The controller 270 may distinguish a touch by a pen from a touch by the hand 1 based on the calculated magnetic field value applied by the magnet 20 of the writing tool 100, and may perform an operation, for example, deleting of a stroke determined as the touch by the hand 1 from the display 230, analyzed based on the magnetic field value.

While a user uses the writing tool 100, the controller 270 may determine whether the ambient magnetic field (Ex, Ey, Ez) is accurately analyzed using the following schemes. In a scheme 1), when a magnetic field sensor value discontinuously changes at an impossible speed, a value of the ambient magnetic field (Ex, Ey, Ez) may be determined to be changed based on a change in a magnetic field sensor value due to an internal reason of the user input processing device 200. In a scheme 2), because the gyroscope 212 or the accelerometer 214 is included in addition to the touch screen and the magnetic field sensor 210, a value of the ambient magnetic field (Ex, Ey, Ez) may be determined to change, when the orientation angle of the user input processing device 200 is determined by the gyroscope 212 and the accelerometer 214 to change above a reference range. In the schemes 1) and 2), until a new ambient magnetic field (Ex, Ey, Ez) is estimated or analyzed, the controller 270 may display all strokes on the display 230 and may perform an operation based on a magnetic field value, for example, deleting of a stroke by the hand 1.

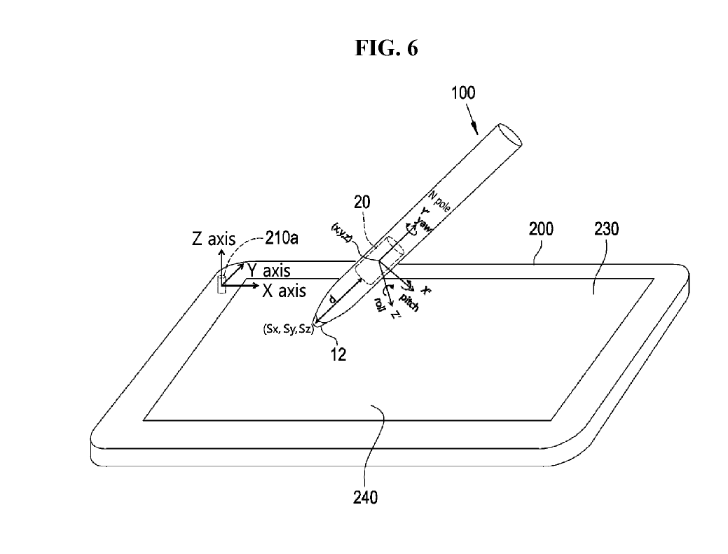

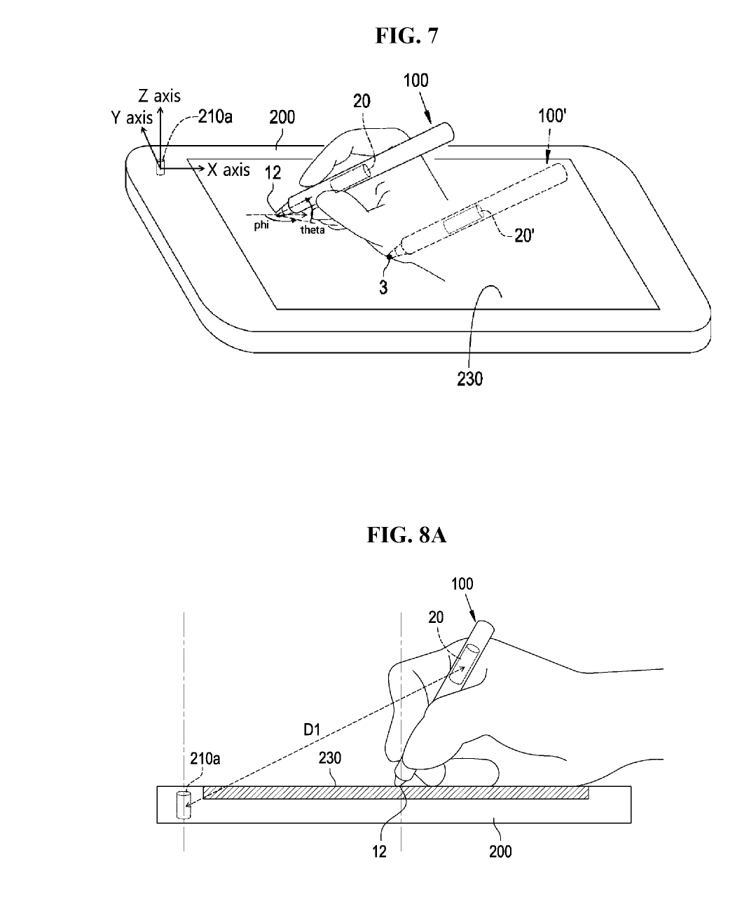

FIGS. 6 and 7 illustrate examples of using the user input processing device of FIG. 1 according to a fifth embodiment.

FIG. 6 illustrates a user input processing device according to the fifth embodiment, and an example in which a single 1-axis magnetic field sensor 210a (for example, a linear hall sensor, and the like) as the magnetic field sensor 210 is mounted near the touch screen. The controller 270 may receive and process a component of a magnetic field vector corresponding to a direction in which the 1-axis magnetic field sensor 210a is placed in a position of the 1-axis magnetic field sensor 210a, may also receive and process a position of a pen point pressing the touch screen, and may display content to be viewed by a user on the display 230. The 1-axis magnetic field sensor 210a senses a value obtained by adding up a magnetic field of the earth and a magnetic field component generated and applied by the magnet 20, and a value of an ambient magnetic field formed by a ferromagnetic substance magnetized close to the 1-axis magnetic field sensor 210a.

For example, when the magnet 20 is a dipole magnet and when a central axis of rotation of the writing tool 100 is matched to a dipole axis Y′ of the magnet 20, the same difference between values of magnetic fields around the magnet as a rotationally symmetric magnetic field generated by the magnet 20 based on the dipole axis Y′ may not be caused by a rotation yaw of the magnet and a pen with the dipole axis Y′ as a central axis. In this example, a rotation element of the magnet 20 may not be measured, and a position and direction of the magnet 20 (that is, the writing tool 100) are described based on five degrees of freedom, for example, a central position (x, y, z) of the magnet, rotation angles roll and pitch about axes X′ and Z′ that are independent of the dipole axis Y′. Thus, for each time, the magnetic field sensor 210a may read a single magnetic field value set by the position and direction of the magnet 20, and a 3D position (Sx, Sy, Sz) in which the pen point 12 of the writing tool 100 including the magnet 20 presses the touch screen at a single time, and may secure four independent sensor values obtained by 1+3=4, however, it is impossible to identify the position and direction of the magnet 20 with five degrees of freedom based on only the above values.

Accordingly, as described above, the controller 270 may receive, as an input, information associated with a writing habit of each user, in particular, information corresponding to angles theta and phi, and may receive, in advance, an input of whether at least one user is right-handed or left-handed or may set the writing habit of each user as a default value. The controller 270 may estimate a position and angle of the dipole magnet 20 in a space from the angles theta and phi of the writing tool 100 and a touch position on the touch screen. A magnetic field value applied by the magnetic field sensor 210a may be calculated based on the estimated position and angle. When a difference between the calculated magnetic field value and an actually measured magnetic field value is great, a touch input may be determined not to be a touch input by the writing tool 100. The touch input may be determined to be the touch input by the writing tool 100 only when the difference is within a reference range. For example, when a touch occurring at a position of the palm 3 is assumed as a touch by the pen point 12 as shown in FIG. 7, an estimated position of the magnet 20 may correspond to a writing tool 100′ indicated by a dashed line, and an actual position of the magnet 20 may be closer to the magnetic field sensor 210a than the estimated position. In this example, the controller 270 may control a magnetic field value greater than a magnetic field value calculated by estimating a position indicated by the dashed line to be applied to the magnetic field sensor 210a, and may determine that the position of the palm 3 does not correspond to the touch by the pen point 12.

Also, the controller 270 may perform a calibration process of measuring in advance a value of an ambient magnetic field applied to the magnetic field sensor 210a when the writing tool 100 is spaced far apart from the magnetic field sensor 210a, and may use a magnetic field value obtained by subtracting an ambient magnetic field value from an actually measured magnetic field value of the magnetic field sensor 210a.

As described above, the magnetic field sensor 210a needs to be located in a position in which a difference between a gap (or distance) between the touch position by the pen point 12 and the magnetic field sensor 210a and a gap (or distance) between a touch position by the hand 1 and the magnetic field sensor 210a is maximized. Because most mobile devices are currently used by horizontally or vertically rotating the mobile devices, the controller 270 may instruct the user input processing device 200 including a mobile device to rotate so that the user input processing device 200 may change a position of the magnetic field sensor 210a to a position in which the hand 1 and the writing tool 100 are more easily distinguished. For example, the controller 270 may display a guide image or characters using the display 230 to notify a user that a right-hander rotates the user input processing device 200 to a landscape position and a left-hander rotates the user input processing device 200 to a portrait position for writing. The user input processing device 200 may notify the user of a writing direction or a rotation direction of the user input processing device 200.

The controller 270 may distinguish a touch by the writing tool 100 from a touch by the hand 1, without a need to analyze an ambient magnetic field value in advance through calibration. As described above, the controller 270 may calculate a variation in a magnetic field value measured by the magnetic field sensor 210a, during a period of time from a start time of a touch input on the touch screen to a time within a reference range. For example, when a speed rapidly changes above a reference variation or discontinuously changes, the controller 270 may determine the touch input as the touch by the writing tool 100, and otherwise, may determine the touch input as the touch by the hand 1. Because a movement direction of the magnet 20 is rapidly changed while the pen point 12 is lifted (that is, the touch is removed) at a touch end time as well as a touch start time, when the variation in the magnetic field value is great or discontinuous at an end of a single stroke (a plurality of touches) drawn on the touch screen, the controller 280 may determine the stroke as a stroke by the writing tool 100, and otherwise, may determine the stroke as a touch by the hand 1.

In addition to a scheme by which the controller 270 compares a time at which the variation in the magnetic field value measured by the magnetic field sensor 210a discontinuously changes to the touch start time or the touch end time, as described above, the following scheme is used:
From a typical speed at which the magnet 20 and the writing tool 100 held by the hand 1 moves downwards to the touch screen immediately before the touch starts, and
from a position of the magnet 20 to be estimated from a position of a touch of the pen point 12 on the touch screen as described above,

a change speed (for example, a reference change speed) of a magnetic field applied to the magnetic field sensor 210a by the magnet 20 moving at a typical speed is estimated in a position of the magnet 20 estimated immediately before the touch starts.

The controller 270 may compare the estimated reference change speed to a change speed of a magnetic field value actually measured by the magnetic field sensor 210a during a period of time from a time before the touch starts on the touch screen to a touch time, and may determine the touch as the touch by the writing tool 100 when a difference between the reference change speed and the change speed is within a reference range. Because a magnetic field is attenuated in proportion to the cube of a distance to the magnet 20, when the writing tool 100 moves in a position close to the magnetic field sensor 210a in comparison to the touch position, the magnetic field may change at a speed much greater than an estimated speed, and when the writing tool 100 is located in a long distance in comparison to the touch position, the magnetic field may change at a speed much less than the estimated speed. Thus, the above scheme may provide considerable discrimination even though calibration is not performed.

As described above, the writing tool 100 is held by the user at a predetermined angle by the writing habit of the user, and accordingly the magnet 20 moves substantially in parallel to the pen point 12 in the space. The controller 270 may estimate a position of the magnet 20 moving substantially in parallel to the pen point 12 with respect to the magnetic field sensor 210a from a relative position between a trajectory of the pen point 12, that is, a stroke on the touch screen and the magnetic field sensor 210a. For example, when the pen point 12 touching the touch screen moves away from the magnetic field sensor 210a, a magnetic field value by a magnet 11 measured by the magnetic field sensor 210a may be reduced by the same value as a distance of the magnet 20 moving away from the magnetic field sensor 210a by parallel movement. When the pen point 12 approaches the magnetic field sensor 210a, the magnetic field value measured by the magnetic field sensor 210a may rapidly increase by a magnetic field by the magnet 20.

When a stroke input on the touch screen and a magnetic field value measured by the magnetic field sensor 210a are determined to change by a substantially parallel to movement based on predetermined angles (for example, an azimuth angle phi and an angle theta of inclination) at which the pen point 12 and the magnet 20 are estimated, the controller 270 may determine and process the stroke as a touch input by the writing tool 100, and otherwise, may determine and process (for example, ignore) the stroke as a touch input by the hand 1 (that is, a palm resting function may be performed). For the above estimation, as described above, the controller 270 may assume the angles theta and phi of the writing tool 100 based on a writing habit of a user (for example, a right-hander or a left-hander) as reference ranges, may assume that the angles theta and phi remain unchanged in a single stroke or several strokes even though the angles theta and phi are unknown, and may estimate the angles theta and phi through parameter fitting or nonlinear optimization to obtain values of the angles theta and phi for best describing a change in magnetic field values sensed at each position of the pen point 12 by the magnetic field sensor 210a. Through the above estimation, the controller 270 may analyze the angles theta and phi at which the user holds the writing tool 100, and may output or process currently executed software (for example, a program) differently based on the angles theta and phi at which the user holds the writing tool 100.

Unless a magnetic field source that is variable and strong enough to have an influence on a magnetic field value measured by a magnetic field sensor 210a is located around the magnetic field sensor 210a, the same ambient magnetic field may have an influence on the magnetic field sensor 210a while a direction in which the user input processing device 200 is placed is not greatly changed. For example, in the above-described Equations 3 through 5, by subtracting a magnetic field value of one time (for example, a second time) from a magnetic field value of another time (for example, a first time), the same ambient magnetic field value in the two times may be excluded. In this example, when a difference between a difference value between the magnetic field values of the two times and a change in a magnetic field value having an influence on the magnetic field sensor 210a by a position of the magnet 20 moving in parallel to a position of the pen point 12 moving during the two times is within a reference range, the controller 270 may determine an input as a stroke input by the writing tool 100, and otherwise, may determine the input as a stroke by the hand 1, instead of needing to separately obtain an ambient magnetic field value through calibration, and the like. In other words, the controller 270 may set two predetermined times at which the pen point 12 is in contact with the touch screen, may calculate a difference between magnetic field values measured by the magnetic field sensor 210a at the two times, may calculate magnetic field values measured by the magnetic field sensor 210a by a position of the magnet 20 estimated based on a position of the pen point 12 for each of the two times, may calculate a difference between the calculated magnetic field values, and may determine whether a difference between the calculated difference and a difference between magnetic field values actually measured by the magnetic field sensor 210a at two times is within a reference range. When the difference is determined to be within the reference range, the controller 270 may determine a touch input at each of the two times as a stroke input by the writing tool 100. When the difference is determined to exceed the reference range, the controller 270 may determine and process the touch input as a stroke input by the hand 1. Through the above process, a touch by the writing tool 100 and a touch by the hand 1 may be distinguished from each other even though a process of acquiring, in advance, an ambient magnetic field value through calibration is not performed.

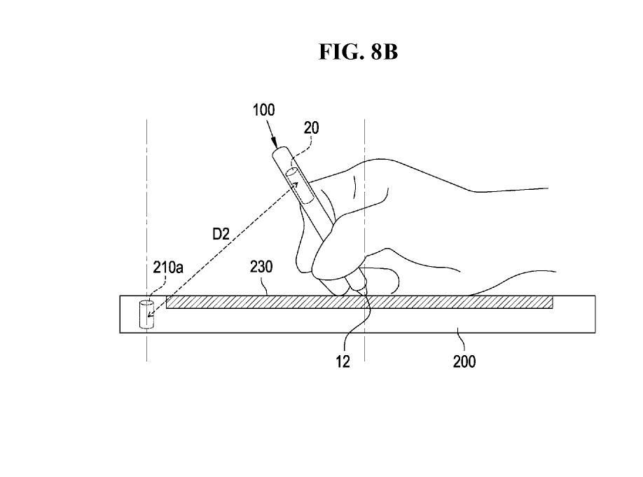

FIGS. 8A and 8B illustrate examples in which a user input processing device and a writing tool are located at different angles, for example, angles theta and phi.

For example, even though the pen point 12 touches the same position on the touch screen, a user may hold the writing tool 100 in a lower right end as shown in FIG. 8A, or hold the writing tool 100 so that the writing tool 100 is inclined to be close to an upper left end as shown in FIG. 8B. In this example, distances (for example, distances D1 and D2) between the magnetic field sensor 210 and the magnet 20 of the writing tool 100 are different from each other. A magnetic field value measured by the magnetic field sensor 210a may be greatly changed by a position of the magnet 20 changed based on when the writing tool 100 is held at a general writing angle as shown in FIG. 8A and when the writing tool 100 is held at an inclination or an azimuth angle different from the angle of FIG. 8A as shown in FIG. 8B, and the controller 270 may receive the magnetic field value of the magnetic field sensor 210a and may perform processing for each magnetic field value. For example, when a writing operation is performed on the touch screen, the controller 270 may perform a conversion to a write function when the user holds the writing tool 100 as shown in FIG. 8A, or perform a conversion to an erase function when the user holds the writing tool 100 as shown in FIG. 8B, may distinguish processing to draw a stroke from processing to erase a stroke based on an angle at which the user holds the writing tool 100, and may perform the processing. Generally, based on a change in a magnetic field applied to the magnetic field sensor 210a due to a change in a distance between the magnetic field sensor 210a and the magnet 20 of the writing tool 100 when the user changes a direction in which the writing tool 100 is inclined for a single touch position, the controller 270 may process different operations in currently executed software (for example, a program). When a number of magnetic field sensors 210a increases, instead of a single magnetic field sensor 210a, a more precise change in a magnetic field may be measured and an azimuth angle and inclination may be finely measured.

Based on a configuration of FIG. 2, the controller 270 may estimate a position of the pen point 12 of the writing tool 100 close to the touch screen when the pen point 12 is floating above the touch screen instead of being in contact with the touch screen. Accordingly, even though a user does not touch the touch screen with the pen point 12, the controller 270 may display the estimated position of the pen point 12 using, for example, a cursor, on the display 230. When the controller 270 is enabled to display a cursor on the display 230 by estimating the position of the pen point 12 even though the writing tool 100 is floating in the air, it is useful for an environment, for example, a trackpad, in which a touch input and a display on a screen are performed in different positions. In other words, when a separate display device exists, a position of the pen point 12 may need to be displayed using a cursor on a separate screen even though the writing tool 100 is floating and moves in the air, and accordingly a user may verify with eyes of the user, on the separate screen, a touch start position when the trackpad is touched again by the writing tool 100 floating above the trackpad.

A general tablet may be used as a trackpad of a separate computer. In other words, the tablet may be connected to the separate computer via a wired or wireless communication, for example, a wireless fidelity (Wi-Fi), Wi-Fi direct, Bluetooth, Ethernet, a universal serial bus (USB), and the like, and may transmit, to the computer, an estimated position of a pen point floating above a touch screen of the tablet or a position of an actual touch by a writing tool. The computer may receive the position of the pen point, may process the position of the pen point in a mouse device driver, and may operate a mouse cursor of the computer. A mouse of the computer may simply move based on the estimated position of the floating pen point, and a movement position by the actual touch may correspond to a “drag” operation of moving the cursor while a button of the mouse is pressed.

Because the magnet 20 and the writing tool 100 floating in a space have five degrees of freedom described as (x, y, z, roll, pitch), as described above, it is impossible to limit the position of the pen point 12 based on only a magnetic field value (for example, Bx, By and Bz) sensed by the 3-axis magnetic field sensor 210 without an input of a touch position (Sx, Sy, Sz) on the touch screen. In other words, to know a position of a pen having five degrees of freedom, two constraints obtained by “5−3=2” in addition to constraints by three equations associated with three magnetic field values, for example, Bx, By and Bz, may be set to obtain values Sx, Sy and Sz. In other words, a number of constraints may need to be equal to or greater than a number of degrees of freedom to limit a position to a single point. When Sx, Sy and Sz are unknown, Equation 2 may be redefined below.

B″(Sx,Sy,Sz,theta,phi) [Equation 6]

In addition to actually measured values Bx, By and Bz to limit a space position (Sx, Sy) of the pen point 12 (for example, a position of a floating pen point on a screen), constraints may be further set. For example, the controller 270 may use a realistic assumption that each of the angles theta and phi between the writing tool 100 and the touch screen is within a preset range or has a specific value based on whether a user is right-handed or left-handed.

In other words, Sz may be assumed as “0” under assumption that a pen point is very close to a surface of a screen, and most users may incline and hold the writing tool 100 so that a normal vector between the writing tool 100 and the touch screen is about 45 degrees, and accordingly the angle theta may be set to 45 degrees. When a constraint that a position (Sz=0) and directivity (theta=45 degrees) are approximately set, and magnetic field values Bx, By and Bz read from a magnetic field value are substituted into Equation 6, the controller 270 may obtain a position (Sx, Sy) even though a touch is not performed. In another example, when an angle phi of 45 degrees (indicating that a pen is inclined to a lower right side) is estimated as a constraint, actually measured magnetic field values Bx, By and Bz, the angle phi of 45 degrees and the angle theta of 45 degrees may be substituted into Equation 6, and the controller 270 may obtain a position (Sx, Sy, Sz). The controller 270 may use the position (Sx, Sy) as a position of a cursor displayed on the display 230 or use the position (Sx, Sy) to perform a function of software associated with an icon located in the position (Sx, Sy). In addition to the above scheme, the controller 270 may perform parameter fitting on continuously obtained values, may more accurately obtain the position (Sx, Sy, Sz) or obtain coordinates of Sx, Sy, and may display the position using a cursor on the display 230. When the user moves the writing tool 100 closer to the touch screen, a value of Sz may be closer to “0,” and accordingly a position of the cursor may be more accurately obtained. When the user actually touches the touch screen, an actual position of a pen point may be displayed through an input on the touch screen. An estimated value of the angle theta or phi may be obtained using a statistical scheme, for example, a scheme by which the controller 270 stores an angle of the writing tool 100 obtained when the writing tool 100 actually starts to touch each position of the touch screen, and calculates an average. A degree by which a joint of a user is rotated may change based on the position (Sx, Sy) on the touch screen, and accordingly different angle values may be applied for each position.

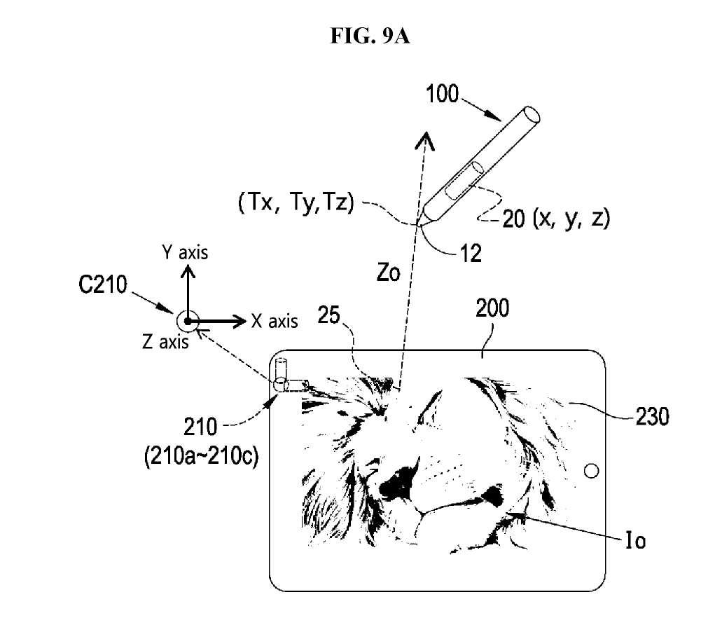

FIGS. 9A and 9B illustrate examples of a zoom function based on a position of a writing tool in a user input processing device. FIGS. 9A and 9B illustrate an example of zoom-out and an example of zoom-in, respectively, and display switching between full content and detailed content may be intuitionally provided to a user. FIG. 9A illustrates a zoomed-out full image Io when the writing tool 100 moves away from the touch screen in a direction of a trajectory Zo indicated by an arrow, and FIG. 9B illustrates a zoomed-in detailed image Ii when the writing tool 100 moves closer to the touch screen in a direction of a trajectory Zi indicated by an arrow. Thus, it is possible to easily enable a detailed manipulation of an image or content displayed on the display 230.

In particular, when a central point (or an origin) zoomed on the touch screen is a point 25 at which a line extending from the trajectories Zo and Zi, that is, 3D trajectories of a pen point meets the touch screen, the controller 270 may physically fix content (for example, data) of the point 25 a user desires to touch with the pen point 12 while contents on the touch screen (that is, the display 230) are updated by zoom-in/out, and may allow the user to conveniently touch the point 25.

To know coordinates of the point 25 as the central point for zoom-in and zoom-out operations, the controller 270 may analyze the 3D trajectory Zo or Zi of the pen point 12 and may obtain an intersection point with a touch screen with a known constant z. In the examples of FIGS. 9A and 9B,

1) the user input processing device 200 includes three 1-axis magnetic field sensors, for example, magnetic field sensors 210a, 210b and 210c, capable of measuring three degrees of freedom,

2) the controller 270 notifies, using the display 230, and the like, a user of calibration of measuring an ambient magnetic field by moving the writing tool 100 away from the magnetic field sensors 210a through 210c, and analyzes the ambient magnetic field, and

3) the writing tool 100 is inclined at a constant azimuth angle phi and a constant angle theta of inclination in a sensor coordinate system C210, and the controller 270 stores the above angles (that is, writing information) based on an input of a user.

In the above examples, the writing tool 100 may move with three degrees of freedom in which only spatial coordinates (x, y, z) of the pen point 12 change in a state in which the angles theta and phi substantially remain unchanged. Accordingly, the controller 270 may receive, as inputs, magnetic field values of three magnetic field sensors, for example, the magnetic field sensors 210 through 210c, may calculate a position of the magnet 20 that is most suitable for or corresponds to the magnetic field values measured by the magnetic field sensors 210a through 210c using a scheme of solving a nonlinear equation or a nonlinear optimization, and may determine a position of the pen point 12 based on the calculated position. In other words, magnetic field values Bx, By and Bz measured by the magnetic field sensors 210a through 210c may be determined based on a 2D angle (for example, angles theta and phi) at which a dipole of the magnet 20 is located and a 3D position (x, y, z) of the magnetic field sensors 210a through 210c, and various nonlinear equations B for obtaining a magnitude of a magnetic field in a space have been well known in the related art. In other words, Equation 7 may be obtained as shown below.

(Bx,By,Bz)=B(x,y,z,theta,phi) [Equation 7]

A 3D position (Tx, Ty, Tz) of the pen point 12 is calculated by a simple conversion f using a position (x, y, z) of the magnet 20 and known constants theta and phi. When the known constants theta and phi are excluded, Equation 8 may be established as shown below.

(x,y,z)=f(Tx,Ty,Tz) [Equation 8]

When Equation 8 is substituted into Equation 7 and the known constants theta and phi are excluded, Equation 9 may be obtained as shown below.

(Bx,By,Bz)=B′(Tx,Ty,Tz) [Equation 9]

Values Tx, Ty and Tz that best correspond to the magnetic field values Bx, By and Bz measured by the magnetic field sensors 210a through 210c may be obtained by substituting actually measured input values Bx, By and Bz into Equation 9 and by performing a nonlinear optimization on Equation 9. In other words, the controller 270 may calculate the position (Tx, Ty, Tz) of the pen point 12 in which a difference between the actually measured values Bx, By and Bz and magnetic field values calculated using the function B′ is minimized based on a predetermined criterion. Also, to obtain the values Tx, Ty and Tz, the controller 270 may perform a numerical analysis algorithm of obtaining a solution of three simultaneous equations with three variables, in addition to the nonlinear optimization. In addition, the controller 270 may obtain the values Tx, Ty and Tz using various schemes, for example, a scheme of actually measuring, in advance, a magnitude vector of a magnetic field signal and all touch inputs on the touch screen to be detected by a direction vector and an available position of the magnet 20, of storing the above measured data in a data table, of searching for the closest value to values actually detected by the magnetic field sensors 210a through 210c from the data table and of searching for values Tx, Ty and Tz corresponding to the found value or interpolating a plurality of obtained candidate variables.

The controller 270 may acquire the trajectories Zo and Zi of the pen point 12 from the position (Tx, Ty, Tz) of the pen point 12 and continuous coordinates of the position, may calculate the point 25, that is, an intersection point between the acquired trajectories Zo and Zi and the touch screen (that is, the display 230 and the inputter 240), and may use the point 25 as a central point or origin to zoom content displayed on the touch screen.

By using a movement of a writing tool with measured three degrees of freedom, 1D zooming and 2D panning of content displayed on the touch screen may be simultaneously performed. In other words, the controller 270 may determine a zoom magnification of content displayed on the touch screen based on Tz that denotes a degree by which the pen point 12 is spaced vertically apart from the touch screen among coordinates Tx, Ty and Tz of the pen point 12, and may determine and adjust an offset position, that is, panning on a 2D plane of the content displayed on the touch screen based on Tx and Ty. In an example of zooming, a zoom-out operation may be intuitively performed when a distance between the writing tool 100 and the touch screen increases in many cases. In an example of panning, when a size (Mx, My) of the touch screen (that is, the display 230) of the user input processing device 200 is smaller than a size (Cx, Cy) of content, an offset (Ox, Oy) may be determined based on components x and y that are substantially parallel to the touch screen in a position in which the pen point 12 is floating, due to a problem of outputting content corresponding to a range of offset (Ox, Oy) to (Ox+Mx, Oy+My) in full content by scrolling in an X-axial direction and Y-axial direction. In many cases, intuitively, (Ox, Oy) and (Tx, Ty) may be output to change in the same direction. Zooming and panning may be performed using the writing tool 100 including the magnet 20 based on the position in which the pen point 12 is floating, however, there is no limitation thereto. For example, when the user input processing device 200 includes a depth sensor or a pantoscopic camera to capture a direction in which the writing tool 100 is floating, a 3D position of the pen point 12 may be analyzed using the above sensors, and zooming and panning may be performed based on recognized coordinates of the pen point 12. Also, zooming and panning may be performed by recognizing a direction and a position of a finger or a palm instead of a pen point that is a separate pointing device, or may be performed based on a distance between the touch screen and eyes (or glasses) of a user gazing the user input processing device 200 or based on a position of projection onto the touch screen.

Generally, in an example in which a limited number N of sensors exist, when it is natural that a user restricts M degrees of freedom (in which M is less than N) of a physically manipulable object by “M−N” degrees of freedom and moves the object, the user may not experience inconvenience. In this example, the controller 270 may provide a notification to perform the above manipulation, may assume a movement of the object with N degrees of freedom, may measure the movement using the N sensors, and may measure a direction or position of the object by limiting the position or direction.

In this example, when the user holds and moves the writing tool 100 at an angle different from the azimuth angle phi and the angle theta of inclination assumed by the user input processing device 200, an error in calculation of a central point for zooming may occur by a difference between the angles. Also, when a writing operation is initiated, an ambient magnetic field value needs to be obtained through calibration. In addition, when the user input processing device 200 is a small device, for example, a small phone or smartwatch, used while moving at all times, calibration may be frequently performed, which may cause inconvenience. To overcome the above disadvantages, the controller 270 may store the following assumptions:

1) While the writing tool 100 moves closer to (or away from) the touch screen once, the azimuth angle phi and the angle theta substantially remain unchanged based on the sensor coordinate system C210. The angles phi and theta remain unchanged when the above movement of the writing tool 100 is performed once, however, may change every time the writing tool 100 moves closer to (or away from) the touch screen in next times.

2) The writing tool 100 moves at a constant velocity over 3D rectilinear trajectories Zi and Zo during a predetermined period of time in which the writing tool 100 moves closer to (or away from) the touch screen once.

In the above assumption of the movement at the constant velocity, the movement of the writing tool 100 closer to or away from the touch screen is a 1D movement. In other words, although a large number of numerical values, for example, an initial position (Ix, Iy, Iz) of the pen point 12 in 3D, a velocity (Vx, Vy, Vz) of the pen point 12, the azimuth angle phi and the angle theta of inclination, and the like, are unknown, these constant parameters may substantially remain unchanged during the movement. Although values Ex, Ey and Ez of an ambient magnetic field are also unknown through calibration, the values may be assumed as constant parameters that remain unchanged for a relatively short period of time in which the writing tool 100 moves closer to or away from the touch screen. The controller 270 may notify a user, using the display 230 that the user moves the writing tool 100 by at least a predetermined distance for movement of the writing tool 100 closer to or away from the touch screen, along with a zooming operation, and moves the writing tool 100 so that a constant angle and a constant velocity of the writing tool 100 are maintained. Under the above assumptions, the controller 270 needs to know 11 parameters, that is, Ix, Iy, Iz, Vx, Vy, Vz, phi, theta, Ex, Ey and Ez, to determine an origin for zooming on the touch screen. Because a nonlinear equation includes the 11 parameters as variables even though three magnetic field values are measured at a single time by three 1-axis magnetic field sensors, for example, the magnetic field sensors 210a through 210c, it is impossible to limit and obtain all the parameters by substituting magnetic field values read at a single time into an equation. However, 12 simultaneous equations may be obtained from 12 magnetic field values as a result of “3×4” measured by the 3-axis magnetic field sensors 210 at four different times. Because the 11 parameters are individual values regardless of a time in the 12 simultaneous equations, a number of parameter values less than a number of simultaneous equations may be calculated when the magnetic field values are measured at the four different times. To obtain exact values, the four different times may be selected so that positions of the writing tool 100 for each time may be far enough away from each other and may be independent of each other.

The controller 270 may perform parameter fitting on all sampled magnetic field sensor values to further increase accuracy. In an example of t=0, when the pen point 12 moves at a unknown velocity (Vx, Vy, Vz) from a unknown initial position (Ix, Iy, Iz) along the trajectory Zi of FIG. 9B, a position of the pen point 12 estimated at a time t may be represented as shown in Equation 10 below.

(Tx(t),Ty(t),Tz(t))=(Ix+Vx×t,Iy+Vy×t,Iz+Vz×t) [Equation 10]

An angle and position of the magnet 20 in the sensor coordinate system C210 may be set by the position of the pen point 12 and unknown angles phi and theta, and magnetic field values applied to the magnetic field sensors 210a through 210c at the set angle and the set position of the magnet 20 may be described based on a nonlinear function B1, and the like. Also, because the values Ex, Ey and Ez of the ambient magnetic field are unknown, magnetic field values Bx(t), By(t) and Bz(t) measured by the three 1-axis magnetic field sensors, for example, the magnetic field sensors 210a through 210c may need to maximally satisfy a condition, that is, Equation 11 shown below.

Bx(t),By(t),Bz(t))=B1(Ix+Vx×t,Iy+Vy×t,Iz+Vz×t,theta,phi)+(Ex,Ey,Ez)[Equation 11]

A vector function B2 defined for each variable to obtain the function B1 from Equation 11 may be represented by Equation 12 as shown below.

Bx(t),By(t),Bz(t))=B2(Ix,Iy,Iz,Vx,Vy,Vz,theta,phi,Ex,Ey,Ez,t)

The controller 270 may need to obtain values of parameters by substituting magnetic field values measured at a plurality of times into the above equation. Error(ti) denoting a difference vector obtained by subtracting a vector obtained by substituting a measurement time ti into a variable t of the vector function B2 in a right side from a magnetic field vector (Bx(ti), By(ti), Bz(ti)) actually measured at a time t (for example, times t1, t2, t3, ti and tn) may be represented by Equation 13 as shown below.

Error(ti)=|(Bx(ti),By(ti),Bz(ti))−B2(Ix,Iy,Iz,Vx,Vy,Vz,theta,phi,Ex,Ey,Ez,ti)| [Equation 13]

Error(ti) refers to an error between a sensor value actually measured at the time ti and a sensor value calculated by estimated parameter values Ix, Iy, Iz, Vx, Vy, Vz, theta, phi, Ex, Ey and Ez. The controller 270 may set parameter values to reduce the error Error(ti) with actually measured values at all times ti (i=1, . . . , n) at which magnetic field values are measured, which may be, for example, an optimization problem to search for a parameter value minimizing Equation 14 shown below.

sum[Error(ti)*Error(ti)],i=1 . . . n (sum[ ] denotes a sum of all terms) [Equation 14]

For a fitting algorithm to obtain an optimum parameter value for the above nonlinear equation, various methods, for example, a Levenberg-Marquardt method, have been known. Also, various criteria, in addition to a square of a length of a difference vector between an actually measured vector and an estimated vector, may be defined as errors. In addition, errors for each time ti (i=1, . . . , n) may be added up using various methods, for example, a normalization of an error of each time by a statistical variance or a normalization of an error of each time based on a value actually measured at each time.

The controller 270 may calculate the velocity (Vx, Vy, Vz) and the initial position (Ix, Iy, Iz) of the pen point 12 by the above parameter fitting, and may calculate coordinates of the point 25 of FIGS. 9A and 9B as an origin for zooming based on the calculated velocity and the calculated initial position. Accordingly, a separate calibration may not need to be performed. Also, the controller 270 may analyze the angles theta and phi for inclination, to differently process software based on whether the writing tool 100 inclined at a predetermined angle moves closer to or away from the touch screen. For example, the controller 270 may need to determine whether the writing tool 100 moves at a constant velocity for current zooming or moves near the touch screen by another intention. In this example, the controller 270 may calculate goodness of fit, may determine that a user intends to perform zooming only when a sufficiently high goodness of fit is measured, and may zoom an image or content on an actual touch screen.

When a size of the user input processing device 200 or the touch screen decreases similarly to a smartwatch, importance to precisely set a trajectory along which the pen point 12 approaches and set the intersection point 25 of the touch screen an origin for zooming may decrease. (Vx/Vz, Vy/Vz) indicating a degree by which the trajectory along which the writing tool 100 approaches is inclined with respect to the touch screen, or a point on the touch screen set by (Ix, Iy) may be set as an origin for zooming. Also, the origin for zooming may be set based on the angles theta and phi of inclination of the writing tool 100. An image or content may be displayed on a full touch screen by a zoom-in operation as shown in FIG. 9B, or a portion of the image or content near the point 25 to which the writing tool 100 is moving closer may be zoomed in and displayed. When the writing tool 100 is spaced apart from the touch screen, a portion of the image or content may be zoomed in and displayed. When the writing tool 100 approaches the touch screen within a reference range or actually touches the touch screen, various user interfaces may be enabled to, for example, zoom in the full screen.

Because a straight-line movement, that is, a 1D movement is measured in FIGS. 9A and 9B, two magnetic field sensors, instead of three 1-axis magnetic field sensors, may be used to estimate a point on the touch screen to which the writing tool 100 is moving, by estimating a parameter, and accordingly zooming may be performed based on the point. Also, when zooming is not performed based on the point to which the writing tool 100 is moving, a single magnetic field sensor may be used to sense a change speed of a magnetic field, to perform zooming. Generally, values measured for sufficiently large time intervals in a single period of time may be combined and may remain unchanged while measurement is performed on an object moving with a number of degrees of freedom equal to or less than “N−1” using N sensors, however, unknown K (>N) parameters may be obtained through simultaneous equations, parameter fitting and the above-described nonlinear optimization. Thus, a complex trajectory of a movement of the object may be found. In particular, even though an object is moved and manipulated with M degrees of freedom greater than “N−1,” the controller 270 may notify a user that the user manipulates the object by restricting the M degrees of freedom by “M−(N−1)” degrees of freedom, and may analyze a movement based on magnetic field values measured at a plurality of times from the N sensors under the assumption of a movement of the object with “N−1” degrees of freedom.

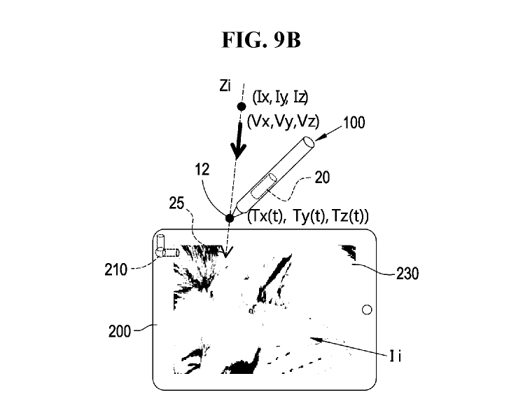

FIG. 10 illustrates an example in which a trajectory along which a writing tool arbitrarily moves on a plane parallel to a touch screen is determined by a magnetic field value of a magnetic field sensor and is displayed. The user input processing device 200 includes three 1-axis magnetic field sensors, for example, magnetic field sensors 210a through 210c, and analyzes a trajectory along which the writing tool 100 including the magnet 20 moves while floating above the touch screen. The controller 270 may notify a user that the user floats and moves the writing tool 100 in the air for arbitrary drawing while maintaining angles theta and phi at which the writing tool 100 is held by the user on a plane. A trajectory Zp along which the user moves the writing tool 100 may be formed on an arbitrary plane, or a plane parallel to the touch screen. The inputter 240 of the user input processing device 200 does not include a touch sensor, and the user may allow the pen point 12 to in contact with a plane of the display 230 for writing. Because the writing tool 100 performs a 2D movement, the controller 270 may calculate the trajectory Zp of the writing tool 100 based on magnetic field values from the three 1-axis magnetic field sensors, for example, the magnetic field sensors 210a through 210c, using the parameter fitting scheme or a scheme of performing a nonlinear optimization based on magnetic field values sampled at several times as described above. A plurality of samples that are sufficiently spaced apart are required to solve an equation or perform the parameter fitting scheme, and accordingly the controller 270 may sufficiently accurately estimate a position of the writing tool 100 after the writing tool 100 moves by a length equal to or greater than a reference length on the plane, instead of performing calculation from a first point of the trajectory Zp. In this example, angles theta and phi associated with inclination of the writing tool 100 may be obtained as parameters.

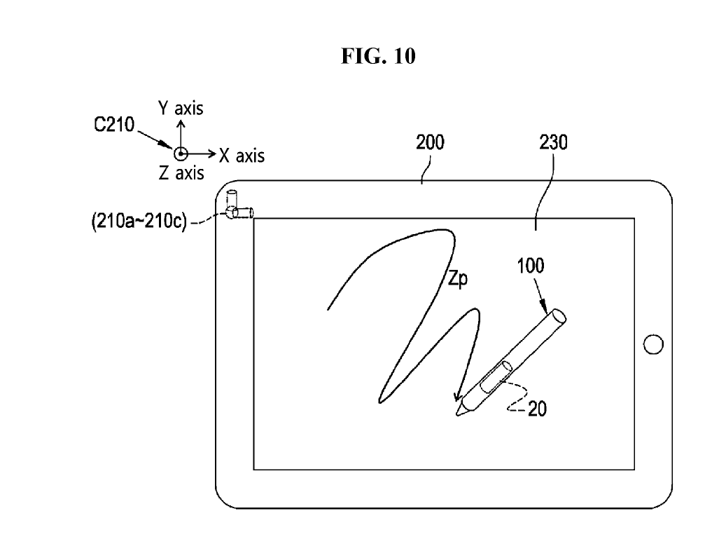

FIG. 11 illustrates an example of using the user input processing device of FIG. 1 according to a sixth embodiment. In the sixth embodiment, five 1-axis magnetic field sensors, for example, magnetic field sensors 210d, 210e, 210f, 210g and 210h are arranged and installed in different directions and are spaced apart by at least a predetermined distance from each other, and a pole (for example, a dipole) of the magnet 20 is disposed in the same direction as a central axis of the body portion 10 in the writing tool 100. In the above configuration, through the above-described calibration process of spacing the writing tool 100 apart from the user input processing device 200, the controller 270 may calculate all angles theta and phi corresponding to two degrees of freedom and a central position (x,y,z) with three degrees of freedom of the magnet 20 and the writing tool 100 floating in the air from five simultaneous equations with five variables as described above, after analyzing an ambient magnetic field value measured by each of the magnetic field sensors 210e through 210h. Accordingly, the controller 270 may analyze a position of the magnet 20 or the pen point 12, a direction 111 (that is, a direction of the dipole of the magnet 20) in which the pen point 12 points to, an extension line 112, and an intersection point 26 at which the extension line 112 meets the touch screen (for example, the display 230 and the inputter 240).

When a position of the intersection point 26 is displayed using a cursor on the display 230 or a cursor is located on the intersection point 26, the controller 270 may control currently executed software to perform a specific operation based on the above direction and intersection point. The controller 270 may zoom and pan content displayed on the touch screen based on a space position of the pen point 12 and the direction 111 in which the pen point 12 points to. For example, when the direction 111 in which the pen point 12 points to forms an angle close to a right angle with the touch screen, the controller 270 may zoom and pan the content displayed on the touch screen based on a 3D position of the pen point 12 using the same method as described above. When angles a difference between the right angle and an angle at which the writing tool 100 is held by a user exceeds a reference range, the controller 270 may control zoom and pan functions not to be performed. When an angle at which the pen point 12 points to the touch screen is closer to the right angle, the controller 270 may change a speed at which the zoom and pan functions are performed to increase.

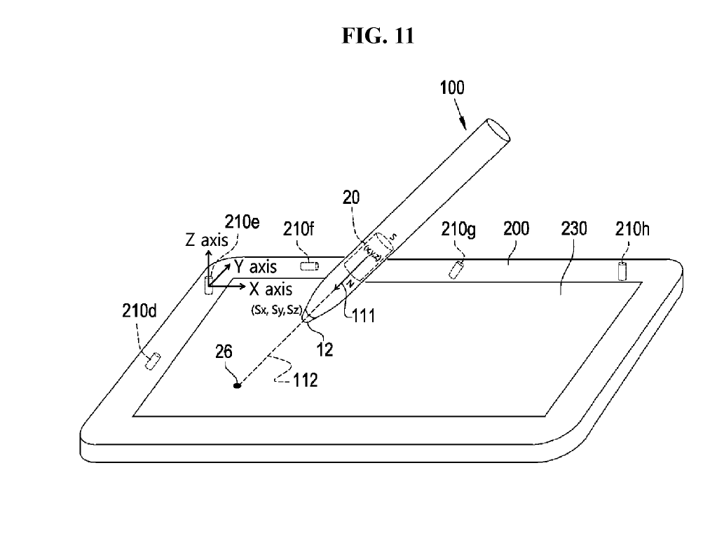

FIG. 12 illustrates an example using the user input processing device of FIG. 1 according to a seventh embodiment. In the example of FIG. 12, two 3-axis magnetic field sensors, for example, the magnetic field sensors 210-1 and 210-2, are spaced apart by at least a predetermined distance, and a position and angle of the writing tool 100 floating in the air and moving with five degrees of freedom as described above are measured using six magnetic field sensors in total.

Because a number of magnetic field sensors, for example, the magnetic field sensors 210-1 and 210-2, is greater than a number of degrees of freedom of a movement of the writing tool 100, the position and angle of the writing tool 100 may be measured at each time without a separate assumption, and the controller 270 may estimate unknown parameters, for example, an ambient magnetic field, by performing parameter fitting or a nonlinear optimization from magnetic field sensor values at multiple times, as described above. Unlike the examples of FIGS. 9A, 9B and 10, in the examples of FIGS. 11 and 12, the controller 270 may zoom and pan content displayed on the touch screen based on a space position of the pen point 12 and a direction in which the writing tool 100 is inclined in a space while a user freely moves a pen without a limitation, for example, a constant angle at which the user needs to hold writing tool 100, and may determine whether to perform zoom and pan functions, and a speed at which the zoom and pan functions are performed. The controller 270 may display a cursor on the direction 111 of the dipole of the magnet 20 and the intersection point 26 at which the extension line 112 meets the touch screen on the display 230, or may control currently executed software to perform a specific operation based on a position of the cursor. The above free movement of the writing tool 100 may be measured in the same manner as when magnetic field values are acquired through a communication between two user input processing devices including 3-axis magnetic field sensors 210 when the two user input processing devices move closer to each other as described above with reference to FIG. 5B.

In FIGS. 9A, 9B, 10, 11 and 12, a cursor may be displayed in a position of each of the points 25 and 26 on the display 230, and a difference between coordinates of a pen point pressing a trackpad and a position of the pen point estimated based on magnetic field value of the magnetic field sensor 210 is equal to or greater than about 5 millimeters (mm) in a state in which the writing tool 100 is sufficiently close to the inputter 240. Accordingly, when a gap Sz between the pen point 12 and the touch screen is within a reference distance, the controller 270 may interrupt a display of the cursor.

The user input processing device 200 may not include a display, and may communicate with a computer system including a display using the communicator 220. For example, the user input processing device 200 may have a similar configuration to a trackpad, may include the magnetic field sensor 210 and the inputter 240, may measure magnetic field values of the writing tool 100 and may transmit information on a position and direction of the writing tool 100 to the computer system. The computer system may display a stroke or a touch input of the writing tool 100 on the display included in the computer system. In this example, the stroke or touch input may be discontinuously displayed on the display in the computer system. The controller 270 may determine that a touch occurs in a position estimated by the magnetic field sensor 210 immediately before the trackpad is touched, may subtract a difference between coordinates of an actual touch on the trackpad, may subtract the same value as the difference when the touch moves so that the stroke or touch input may be continuously displayed.

Also, the controller 270 may perform the zoom and pan functions based on a preset specific position or central point on the touch screen, instead of a position of an intersection point of FIGS. 9A, 9B, 11 and 12. For example, when a perpendicular line is extended from the pen point 12 to the touch screen, the controller 270 may use a position of the perpendicular line instead of a previous intersection point. In other words, the controller 270 may calculate a specific position (for example, a control central position) on the touch screen (for example, a display) based on a position and direction of the writing tool 100 (or the magnet 20) on the touch screen, and may perform the zoom and pan functions based on the control central position. The control central position may include the position of the intersection point of FIGS. 9A, 9B, 11 and 12, and the preset specific position or the central position on the touch screen.

The controller 270 may notify a user of a writing posture using the display 230 or the speaker 260 so that a right angle or an angle closer to the right angle between a writing tool and the touch screen is maintained during writing, may limit a position of the writing tool 100 or the magnet 20, and may determine a position or direction based on a magnetic field value. Also, the controller 270 may limit a position of the writing tool 100 on the touch screen during writing. As described above, when the writing tool 100 is located in all positions (x, y) on the touch screen, two parameters among three parameters corresponding to another position (z, theta, phi) may be limited, so that a position of a magnet may be limited by three 1-axis magnetic field sensors to analyze or calculate a position of the writing tool 100. However, the controller 270 may calculate or measure the position of the writing tool 100, based on a constraint (for example, an operation is performed only when the writing tool 100 faces a straight line “y=some_contant” or when a line “0=f(x, y)” is viewed) of the position (x, y), and based on a single assumption that an angle theta is a specific angle. Similarly, the controller 270 may notify a user that at least one of a position and direction (x, y, z, theta, phi) of the writing tool 100 or the magnet 20 is maintained to have a preset value, and may calculate other values using a more limited number of magnetic field sensors.

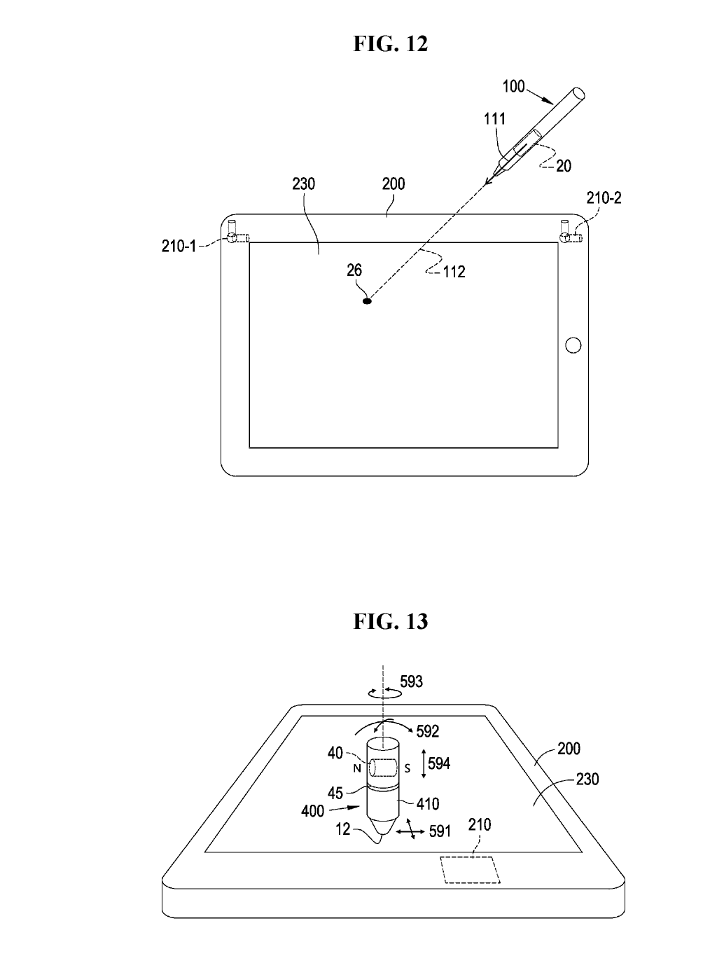

FIG. 13 illustrates another example of using the user input processing device of FIG. 2. FIG. 13 illustrates a joystick 400 as a writing tool enabling simultaneous inputs of five degrees of freedom. Unlike the magnet 20 of the above-described writing tool 100, in the joystick 400 of FIG. 13, a dipole of a magnet 40 is installed in a direction that is not parallel to a rotation axis of a body portion 410 of the joystick 400. The controller 270 may measure a rotation angle yaw 593 of the joystick 400 in addition to an angle theta 591 and an angle phi 592, based on magnetic field values from three 1-axis magnetic field sensors 210. Because a 2D displacement of (Sx, Sy) may be simultaneously measured through the touch screen based on an operation by which the pen point 12 presses the touch screen or releases, five degrees of freedom in total may be input. Thus, a 3D mouse function required for a geospatial application, for example, games, a computer-aided design (CAD), a navigation, or other street views, may be implemented using the general-purpose user input processing device 200 and the low-priced joystick 400. For example, when the user input processing device 200 includes at least four independent 1-axis magnetic field sensors, a length extender 45 to increase a length of the body portion 410 may be mounted below the magnet 40 in the body portion 410, so that the magnet 40 may move in parallel in a rotation axis direction 594 of the joystick 400. In this example, inputs of movements with six degrees of freedom in total may be enabled. In another example, a magnet may be fixed, and the user input processing device may move around the magnet, and accordingly movements with six degrees of freedom may be measured. In this example, when the 3-axis magnetic field sensor 210 is included in the user input processing device 200 but when an input is not performed even though the pen point 12 presses the touch screen, all movements with six degrees of freedom of the user input processing device 200 may be measured at each time based on a total of six input values, that is, three magnetic field values input to the 3-axis magnetic field sensor 210 and three pieces of azimuth angle information input from a 3-axis gyroscope in the user input processing device 200.

A process by which a user input processing device according to the above-described embodiments processes a magnetic field value from a magnetic field sensor, writing habit information of a user, a touch input value, and the like may be stored as a program file in a storage medium. The program file may be transmitted between electrical devices via a network and may be installed in various electrical devices, and the same operation may be performed. In other words, a function performed by the user input processing device may be provided as a program stored in a non-transitory computer-readable storage medium.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A user input processing device using a limited number of magnetic field sensors, the user input processing device comprising:
at least one magnetic field sensor configured to sense a magnetic field, the at least one magnetic field sensor being independent of each other;
a touch inputter configured to sense a touch by a writing tool or by a hand; and
a controller configured to calculate a position or direction of a writing tool or magnetic field generator mounted in the writing tool, based on a current magnetic field value from the magnetic field sensor and a current touch position value of the touch inputter.

2. The user input processing device of claim 1, wherein the controller is configured to receive a plurality of touch position values and a magnetic field value, to calculate an ambient magnetic field value, and to calculate the current magnetic field value based on the calculated ambient magnetic field value.

3. The user input processing device of claim 2, wherein the controller is configured to recalculate the ambient magnetic field value when an orientation angle of the user input processing device changes above a predetermined angle.

4. The user input processing device of claim 1, wherein the controller is configured to calculate an ambient magnetic field value or a scale factor value by a soft iron effect based on magnetic field values in different positions of the writing tool or based on magnetic field values from a plurality of writing tools disposed in different positions, and to calculate the current magnetic field value based on the calculated ambient magnetic field value and the calculated scale factor value.

5. The user input processing device of claim 1, wherein the controller is configured to store writing habit information of a user so that a scheme of displaying a touch position value corresponding to the stored writing habit information is distinguished from a scheme of displaying a touch position value that does not correspond to the stored writing habit information.

6. (canceled)

7. The user input processing device of claim 1, wherein the controller is configured to notify the user of a writing direction or a rotation direction of the user input processing device or of a rotation of the user input processing device based on the installation position information of the magnetic field sensor and the writing habit information of a user so that a difference between a gap between a touch position by the writing tool and the magnetic field sensor and a gap between a touch position by a hand and the magnetic field sensor is maximized.

8. The user input processing device of claim 1, wherein the magnetic field sensor comprises a plurality of magnetic field sensors that are spaced apart by a predetermined distance from each other, that each have a single axis or a plurality of axes, that comprise a first magnetic field sensor and a second magnetic field sensor, and the controller is configured to determine the position or direction of the writing tool based on a difference between magnetic field values from the first magnetic field sensor and the second magnetic field sensor.

9. The user input processing device of claim 1, wherein the user input processing device comprises a communicator configured to communicate with an external device comprising a magnetic field sensor, and is configured to receive a magnetic field value measured by the external device using the communicator and to determine the position or direction of the writing tool based on the received magnetic field value and the current magnetic field value.

10. The user input processing device of claim 1, wherein the controller is configured to calculate a magnetic field value based on the calculated position and an angle of the magnetic field generator, to compare the calculated magnetic field value and a magnetic field value measured by the magnetic field sensor, and to determine a touch input as an input by the writing tool when a difference between the calculated magnetic field value and the measured magnetic field value is within a preset reference range.

11. The user input processing device of claim 1, wherein the controller is configured to calculate a variation in a magnetic field value measured by the magnetic field sensor during a period of time from a start time of a touch input of the touch inputter to a time within a reference range, and to determine the touch input as an input by the writing tool when the calculated variation rapidly changes above a reference variation or discontinuously changes.

12. The user input processing device of claim 1, wherein the controller is configured to compare a reference change speed of a magnetic field estimated immediately before a touch is input by the writing tool to a change speed of a magnetic field value measured by the magnetic field sensor during a period of time from a time before the touch input by the writing tool starts to a touch input time, and to determine the touch input as an input by the writing tool when a difference between the reference change speed and the change speed of the magnetic field value is within a reference range.

13. The user input processing device of claim 1, wherein the controller is configured to determine a touch as an input by the writing tool when it is determined that the writing tool moves in parallel to the touch inputter based on changes in a touch input of the touch inputter and the magnetic field value of the magnetic field sensor.

14. A user input processing device using a limited number of magnetic field sensors, the user input processing device comprising:
at least one magnetic field sensor configured to sense a magnetic field, the at least one magnetic field sensor being independent of each other;
a display configured to display an image or content; and
a controller configured to store writing habit information of a user, and to calculate a position of a writing tool or a magnetic field generator mounted in the writing tool based on a current magnetic field value from the magnetic field sensor and the stored writing habit information.

15. The user input processing device of claim 14, wherein the writing habit information comprises information on a left hand or right hand for writing and a writing angle.

16. The user input processing device of claim 14, wherein the controller is configured to display a cursor on a position of the display corresponding to the calculated position, or to control software associated with an icon that is already displayed on the display.

17. The user input processing device of claim 16, wherein the controller is configured to remove the displayed cursor when the calculated position and the position of the display are within a predetermined distance.

18. The user input processing device of claim 14, wherein the controller is configured to calculate a trajectory left by passage of the writing tool or the magnetic field generator.

19. The user input processing device of claim 18, wherein the controller is configured to zoom or pan the image or content displayed on the display based on the calculated trajectory, and to display the zoomed or panned image or content.

20. The user input processing device of claim 19, wherein the controller is configured to determine a magnification based on a height (that is, a z-axis coordinate) of the writing tool or the magnetic field generator from the display, and to determine a pan component based on a position (that is, an x-axis coordinate and y-axis coordinate) of the writing tool or the magnetic field generator on the display.

21. A user input processing device using a limited number of magnetic field sensors, the user input processing device comprising:
at least one magnetic field sensor configured to sense a magnetic field, the at least one magnetic field sensor being independent of each other;
a display configured to display an image or content; and
a controller configured to receive a plurality of magnetic field values from the magnetic field sensor, to calculate a position or direction of a writing tool or a magnetic field generator mounted in the writing tool, and to calculate a control central position on the display based on the calculated position or the calculated direction.

22. (canceled)

23. (canceled)

24. (canceled)

25. (canceled)
